(19) United States
(12) Patent Application Publication
(10) Pub. No.: US 2017/0177403 A1
(43) Pub. Date: Jun. 22, 2017

(54) METHOD FOR PERFORMING TASK AND ELECTRONIC DEVICE SUPPORTING THE SAME

(71) Applicant: SAMSUNG ELECTRONICS CO., LTD., Suwon-si (KR)

(72) Inventors: Kyuok CHOI, Seoul (KR); Heejin KIM, Seoul (KR); Chulwoo KIM, Suwon-si (KR); Dongjun SHIN, Seoul (KR); Bo-Keun KIM, Suwon-si (KR)

(21) Appl. No.: 15/361,603

(22) Filed: Nov. 28, 2016

(30) Foreign Application Priority Data
Dec. 18, 2015 (KR) 10-2015-0181707

(51) Int. Cl. G06F 9/46; G06F 1/16

(52) U.S. Cl. CPC G06F 9/461; G06F 1/1641

(57) ABSTRACT

A method for performing a task in an electronic device includes: detecting a deformation of at least a part of the electronic device; identifying information on a task which is performed in the electronic device; and restoring the at least a part of the electronic device from which the deformation is detected based on at least the identified information on the task.

### CROSS-REFERENCE TO RELATED APPLICATION

The present application is based on and claims priority under 35 U.S.C. §119 to an application filed in the Korean Intellectual Property Office on Dec. 18, 2015 and assigned Serial No. 10-2015-0181707, the contents of which are incorporated by reference herein in its entirety.

### BACKGROUND

1. Technical Field

The present disclosure relates generally to a method for performing a task and an electronic device supporting the same.

2. Description of Related Art Thanks to the remarkable development of information and communications technology and semiconductor technology, the distribution and use of electronic devices (for example, mobile terminals) are rapidly increasing.

The electronic devices did not stay in their respective transitional fields and have been developed into the stage of convergence embracing fields of other devices. For example, the electronic devices provide various functions such as a timer function, file transmission, playing music, playing a video, or the like to users using applications, in addition to a telephony function.

In recent years, research on flexible electronic devices is being carried out to live up to users' needs for new and various functions. The flexible electronic device refers to an electronic device which has a characteristic of having its shape changed like paper. For example, in the flexible electronic device, an inner configuration including a display can be bent, folded, or rolled.

The flexible electronic device provides a variety of functions using the characteristic of being flexibly deformed. For example, the flexible electronic device may provide a function of outputting a screen through an unfolded portion of the display when the display is folded.

### SUMMARY

There is a need for various methods for using operations of the flexible electronic devices based on the unique characteristic of the flexible electronic device.

Various example embodiments of the present disclosure provide a method for performing a task, which provides a task performance state of an electronic device using operations of deforming a flexible electronic device and returning the deformed electronic device to its original state, and an electronic device supporting the same.

The various aspects addressed by the present disclosure are not limited to the above-mentioned techniques, and other aspects that are not mentioned can be clearly understood by a person skilled in the art based on the following descriptions.

According to various example embodiments of the present disclosure, a method for performing a task in an electronic device includes: detecting a deformation of at least a part of the electronic device; identifying information on a task which is performed in the electronic device; and restoring the at least a part of the electronic device from which the deformation is detected based on at least the identified information on the task.

According to various example embodiments of the present disclosure, an electronic device includes: at least one sensor configured to detect a deformation of at least a part of the electronic device; a driver unit configured to restore the at least deformed part of the electronic device; and at least one processor electrically connected with the at least one sensor and the driver unit, and the processor configured to control the driver unit to detect a deformation of at least a part of the electronic device using the at least one sensor, to identify information on a task which is performed in the electronic device, and to restore the at least a part of the electronic device from which the deformation is detected based on at least the identified information on the task.

### BRIEF DESCRIPTION OF THE DRAWINGS

The above and other aspects of the present disclosure and their attendant advantages, will be more readily understood and appreciated from the following detailed description, taken in conjunction with the accompanying drawings, in which like reference numerals refer to like elements, and wherein:

FIG. 1 is a diagram illustrating an example network environment including an electronic device according to various example embodiments of the present disclosure;

FIG. 2 is a block diagram illustrating an example electronic device according to various example embodiments of the present disclosure;

FIG. 3 is a block diagram illustrating an example program module according to various example embodiments;

FIGS. 4A, 4B, 4C, 4D, 5A, 5B, 6A and 6B are diagrams illustrating an example method for performing a task according to various example embodiments of the present disclosure;

FIG. 7 is a flowchart illustrating an example method for performing a task according to an example embodiment of the present disclosure;

FIG. 8 is a flowchart illustrating an example method for restoring at least a part of the electronic device according to an example embodiment of the present disclosure;

FIGS. 9A and 9B are diagrams illustrating an example method for restoring at least a part of the electronic device according to an example embodiment of the present disclosure;

FIGS. 10A, 10B and 10C are diagrams illustrating an example method for restoring at least a part of the electronic device according to another example embodiment of the present disclosure;

FIGS. 11A, 11B, 12A, 12B, 13A and 13B are diagrams illustrating an example method for restoring at least a part of the electronic device according to still another example embodiment of the present disclosure;

FIG. 14 is a flowchart illustrating an example method for performing a task according to another example embodiment of the present disclosure;

FIGS. 15A, 15B, 15C and 15D are diagrams illustrating an example method for performing a task according to another example embodiment of the present disclosure;

FIGS. 16A, 16B, 16C and 16D are diagrams illustrating an example method for performing a task related to a timer function according to an example embodiment of the present disclosure;

FIGS. 17A, 17B and 17C are diagrams illustrating an example method for performing a task related to an application update function according to an example embodiment of the present disclosure;

FIGS. 18A, 18B and 18C are diagrams illustrating an example method for performing a task related file transmission according to an example embodiment of the present disclosure;

FIGS. 19A, 19B and 19C are diagrams illustrating an example method for performing a task related to a charging function according to an example embodiment of the present disclosure; and

FIGS. 20A, 20B, 20C, 20D, 21A, 21B, 21C, 21D and 21E are diagrams illustrating an example method for performing a task related to an automatic photographing function of a camera according to an example embodiment of the present disclosure.

### DETAILED DESCRIPTION

Hereinafter, various example embodiments of the present disclosure will be described with reference to the accompanying drawings. However, it should be understood that there is no intent to limit the present disclosure to the various forms disclosed herein; rather, the present disclosure should be understood to cover various modifications, equivalents, and/or alternatives of the various example embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various example embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. On the other hand, it may be understood that when an element (e.g., first element) is referred to as being “directly connected,” or “directly coupled” to another element (second element), there are no other elements (e.g., third element) interposed between them.

The expression “configured to” used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. In some situations, the expression “device configured to” may refer, for example, to a situation in which the device, together with other devices or components, “is able to”. For example, the phrase “processor adapted (or configured) to perform A, B, and C” may refer, for example, and without limitation, to a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing various example embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even if the term is defined in the present disclosure it should not be interpreted to exclude embodiments of the present disclosure.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto.

According to some example embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various example embodiments of the present disclosure may be a combination of one or more of the aforementioned various devices. The electronic device according to some example embodiments of the present disclosure may be a flexible device. Further, the electronic device according to an example embodiment of the present disclosure is not limited to the aforementioned devices, and may include a new electronic device according to the development of technology.

Hereinafter, an electronic device according to various example embodiments will be described with reference to the accompanying drawings. As used herein, the term “user” may indicate a person who uses an electronic device or a device (e.g., an artificial intelligence electronic device) that uses an electronic device.

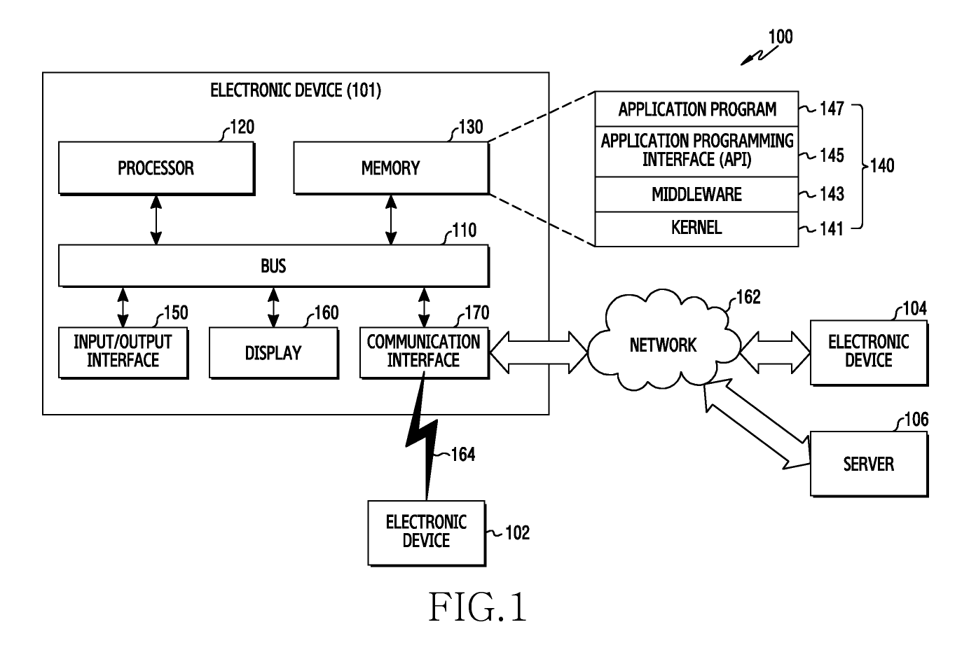

FIG. 1 is a diagram illustrating an example electronic device in a network environment according to various example embodiments of the present disclosure.

An electronic device 101 within a network environment 100, according to various example embodiments, will be described with reference to FIG. 1. The electronic device 101 may include a bus 110, a processor (e.g., including processing circuitry) 120, a memory 130, an input/output interface (e.g., including input/output circuitry) 150, a display 160, and a communication interface (e.g., including communication circuitry) 170. In some example embodiments, the electronic device 101 may omit at least one of the above elements or may further include other elements.

The bus 110 may include, for example, a circuit for connecting the elements 110-170 and transferring communication (e.g., control messages and/or data) between the elements.

The processor 120 may include various processing circuitry, such as, for example, and without limitation, at least one or more of a dedicated processor, a Central Processing Unit (CPU), an Application Processor (AP), and a Communication Processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an example embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more operation requests received from the application program 147 based on priority. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests based on the priority given to the at least one application program.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may include various input/output circuitry configured to function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display, or the like, but is not limited thereto. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may include various communication circuitry configured to set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106). The wireless communication may use at least one of, for example, Long

Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may be performed by using at least one of, for example, Wi-Fi, Bluetooth, Bluetooth low energy (BLE), Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of a communication network such as a computer network (e.g., a LAN or a WAN), the Internet, and a telephone network.

Each of the first and second external electronic apparatuses 102 and 104 15 may be of a type identical to or different from that of the electronic apparatus 101. According to an example embodiment, the server 106 may include a group of one or more servers. According to various example embodiments, all or some of the operations performed in the electronic device 101 may be performed in another electronic device or a plurality of electronic devices (e.g., the electronic devices 102 and 104 or the server 106). According to an example embodiment, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic apparatus may execute the requested functions or the additional functions, and may deliver a result of the execution to the electronic apparatus 101. The electronic device 101 may process the received result as it is or additionally to provide the requested functions or services. To achieve this, for example, cloud computing, distributed computing, or client-server computing technology may be used.

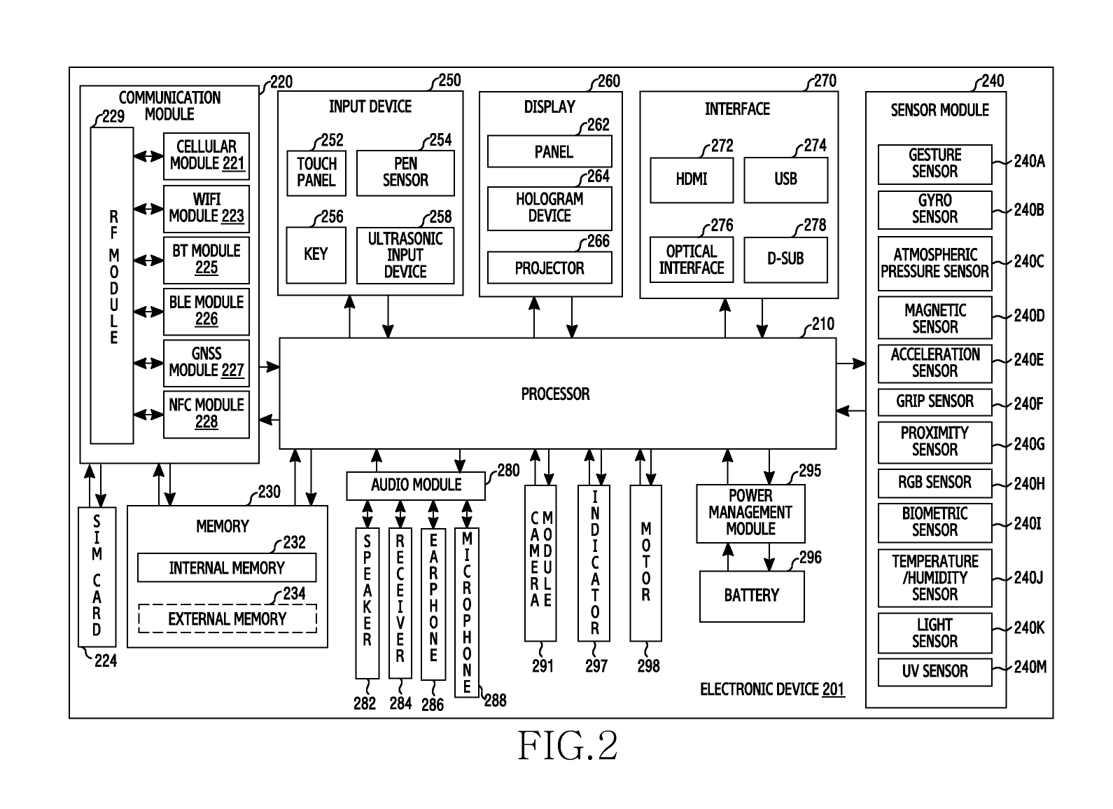

FIG. 2 is a block diagram illustrating an example electronic device according to various example embodiments of the present disclosure.

FIG. 2 is a block diagram of an electronic device 201 according to various example embodiments. For example, the electronic apparatus 201 may include the whole or part of the electronic apparatus 101 illustrated in FIG. 1. The electronic device 201 may include at least one processor (e.g., Application Processor (AP)) (e.g., including processing circuitry) 210, a communication module (e.g., including communication circuitry) 220, a Subscriber Identification Module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may include various processing circuitry configured to control a plurality of hardware or software components connected to the processor 210 by driving an operating system or an application program and perform processing of various pieces of data and calculations. The processor 210 may be implemented by, for example, and without limitation, various processing circuitry (e.g., a dedicated processor, CPU, or the like) implemented as a System on Chip (SoC). According to an example embodiment, the processor 210 may further include a Graphic Processing Unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include various communication circuitry, such as, for example, and without limitation, at least one of the cellular module 221, a Wi-Fi module 223, a Bluetooth (BT) module 225, a Bluetooth low energy (BLE) module 226, a GNSS module 227 (e.g., a GPS module, a Glonass module, a Beidou module, or a Galileo module), an NFC module 228, and a Radio Frequency (RF) module 229.

The cellular module 221 may provide a voice call, image call, a text message service, or an Internet service through, for example, a communication network. According to an example embodiment, the cellular module 221 may distinguish between and authenticate electronic devices 201 within a communication network using a subscriber identification module (for example, the SIM card 224). According to an example embodiment of the present disclosure, the cellular module 221 may perform at least some of the functions that the processor 210 may provide. According to an example embodiment, the cellular module 221 may include a Communication Processor (CP).

Each of the Wi-Fi module 223, the BT module 225, the Bluetooth low energy module 226, the GNSS module 227, and the NFC module 228 may include, for example, a processor for processing data transmitted and received through the relevant module. According to some example embodiments of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229 may transmit/receive, for example, a communication signal (for example, an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the Bluetooth low energy module 226, the GNSS module 227, and the NFC module 228 may transmit and receive RF signals through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (for example, the memory 130) may include, for example, an internal memory 232 and/or an external memory 234. The embedded memory 232 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 may be functionally and/or physically connected to the electronic apparatus 201 through various interfaces.

The sensor module 240 may measure a physical quantity or detect an operation state of the electronic device 201, and may convert the measured or detected information into an electrical signal. For example, the sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 2401, a temperature/humidity sensor 240J, a light sensor 240K, and an Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some example embodiments of the present disclosure, the electronic apparatus 201 may further include a processor configured to control the sensor module 240 as a part of or separately from the processor 210, and may control the sensor module 240 while the processor 210 is in a sleep state.

The input device 250 may include various input circuitry, such as, for example, and without limitation, one or more of a touch panel 252, a (digital) pen sensor 254, a key 256, or an ultrasonic input device 258. The touch panel 252 5 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic apparatus 201. According to an example embodiment, the display 260 may further include a control circuit for controlling the panel 262, 25 the hologram device 264, or the projector 266.

The interface 270 may include various interface circuitry, such as, for example, and without limitation, one or more of a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include other interface circuitry, such as, for example, and without limitation, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some elements of the audio module 280 may be included in, for example, the input/output interface 150 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an example embodiment, the camera module 291 may include one or more image sensors (for example, a front sensor or a back sensor), a lens, an Image Signal Processor (ISP) or a flash (for example, LED or xenon lamp).

The power management module 295 may manage, for example, power of the electronic device 201. According to an example embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic apparatus 201 or a part (e.g., the processor 210). The motor 298 may convert an electrical signal into mechanical vibration, and may generate vibration, a haptic effect, or the like. Although not illustrated, the electronic apparatus 201 may include a processing unit (e.g., a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. The electronic device according to various example embodiments of the present disclosure may include at least one of the aforementioned elements. Some elements may be omitted or other additional elements may be further included in the electronic device. Also, some of the hardware components according to various example embodiments may be combined into one entity, which may perform functions identical to those of the relevant components before the combination.

According to various example embodiments, the electronic device 101 may further comprise a driver unit configured to restore the at least deformed part of the electronic device. For example, the driver unit may include at least one of hinge unit or an element (or a material) which expands or contracts by applying an external power to the electronic device 101. According to various example embodiments, the element (or the material) which expands or contracts by applying an external power to the electronic device 101 may be embodied by ionic polymer-metal composite or shape memory alloys, or the like.

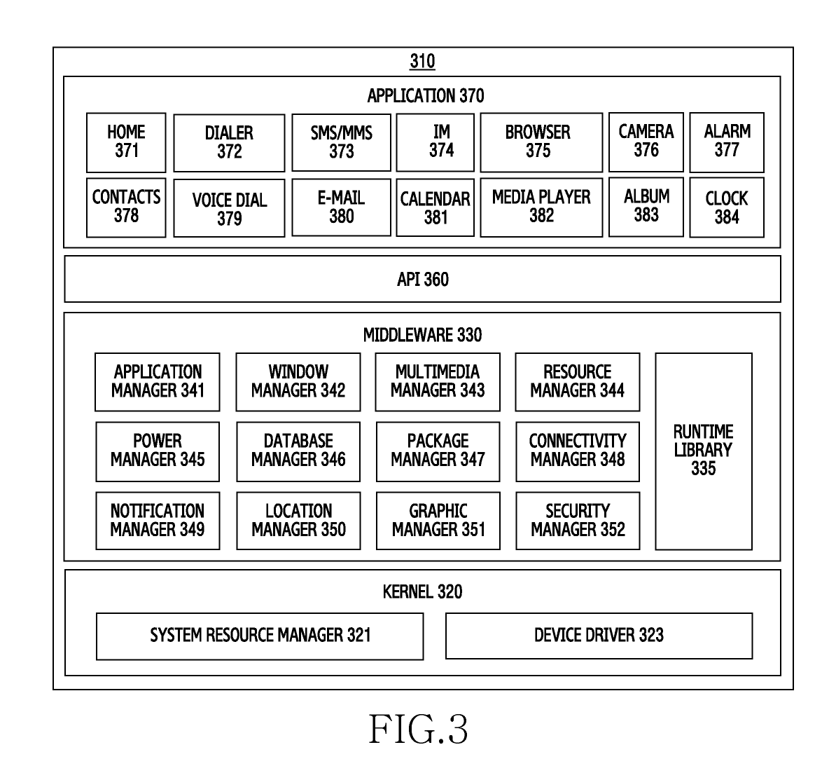

FIG. 3 is a block diagram illustrating an example program module according to various example embodiments of the present disclosure.

According to an example embodiment, the program module 310 (for example, the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic apparatus, or may be downloaded from an external electronic apparatus (e.g., the electronic apparatus 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to an example embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function required by the applications 370 in common or provide various functions to the applications 370 through the

API 360 so that the applications 370 can efficiently use limited system resources within the electronic device. According to an example embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage Graphical User Interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a Basic Input/Output System (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic apparatus. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic apparatus (e.g., the electronic apparatus 101) has a telephone call function, the middleware 330 may further include a telephony manager for managing a voice call function or a video call function of the electronic apparatus.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration based on an OS. For example, in the case of Android or iOS, one API set may be provided for each platform. In the case of Tizen, two or more API sets may be provided for each platform.

The applications 370 (for example, the application program 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an example embodiment of the present disclosure, the applications 370 may include an application (hereinafter, referred to as an “information exchange application” for convenience of description) supporting information exchange between the electronic apparatus (e.g., the electronic apparatus 101) and an external electronic apparatus (e.g., the electronic apparatus 102 or 104). The application associated with information exchange may include, for example, a notification relay application for forwarding specific information to an external electronic device, or a device management application for managing an external electronic device.

For example, the notification relay application may include a function of delivering, to the external electronic apparatus (e.g., the electronic apparatus 102 or 104), notification information generated by other applications (e.g., an SMS/MMS application, an email application, a health care application, an environmental information application, etc.) of the electronic apparatus 101. 25 Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an example embodiment, the applications 370 may include applications (for example, a health care application of a mobile medical appliance or the like) designated according to attributes of the external electronic device 102 or 104. According to an example embodiment of the present disclosure, the application 370 may include an application received from the external electronic apparatus (e.g., the server 106, or the electronic apparatus 102 or 104). According to an embodiment of the present disclosure, the application 370 may include a preloaded application or a third party application which can be downloaded from the server. Names of the elements of the program module 310, according to the above-described example embodiments of the present disclosure, may change depending on the type of OS.

According to various example embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, refer to a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include, for example, and without limitation, at least one of a dedicated processor, a CPU, an Application-Specific Integrated Circuit (ASIC) chip, a Field-Programmable Gate Arrays (FPGA), and a programmable-logic device for performing operations which has been known or are to be developed hereinafter.

The module or the program module, according to various example embodiments, may: include one or more elements described above; exclude some of them; or further include other elements. The operations performed by the module, the program module, or other elements, according to various example embodiments, may be executed in a sequential, parallel, iterative, or heuristic method. In addition, some operations may be executed in a different order, or may be omitted, or other operations may be added. In addition, the embodiments disclosed in the present disclosure are intended for the explanation and understanding of the technical matter, and shall not limit the scope of the technology described in the present disclosure. Accordingly, the scope of the present disclosure should be construed to encompass all modifications or various other embodiments based on the technical concept of the present disclosure.

In addition, the example embodiments disclosed in the present disclosure are intended for the explanation and understanding of the disclosed technical matter, and shall not limit the scope of various example embodiments of the present disclosure. Therefore, the scope of various example embodiments of the present disclosure should be understood to encompass all modifications or various other embodiments based on the technical concept of the various embodiments of the present disclosure.

According to various example embodiments of the present disclosure, an electronic device may include: at least one sensor configured to detect a deformation of at least a part of the electronic device; a driver unit configured to restore the at least deformed part of the electronic device; and at least one processor electrically connected with the at least one sensor and the driver unit, and the processor may be configured to control the driver unit to detect a deformation of at least a part of the electronic device using the at least one sensor, to identify information on a task which is performed in the electronic device, and to restore the at least a part of the electronic device from which the deformation is detected based on at least the identified information on the task.

In an example embodiment, the processor may detect at least one of bending, folding, and rolling of the at least a part of the electronic device using the at least one sensor.

In an example embodiment, the processor may determine whether the task is a task which is designated for restoring the at least a part of the electronic device or not, and the task designated for restoring the at least a part of the electronic device may include a task for which a task performance time is determined when the task is started.

In an example embodiment, the task designated for restoring the at least a part of the electronic device may include a task related to a timer function, a task related to an application update, a task related to file transmission, a task related to file download, a task related to an automatic photographing function of a camera, and a task related to a charging function.

In an example embodiment, the processor may determine whether it is possible to perform the task designated for restoring the at least a part of the electronic device, and, when it is determined that it is possible to perform the task designated for restoring the at least a part of the electronic device, may start performing the task designated for restoring the at least a part of the electronic device.

In an example embodiment, the processor may determine whether to restore the at least a part of the electronic device from which the deformation is detected based on at least the identified information of the task, when it is determined that the at least a part of the electronic device from which the deformation is detected is restored, the processor may restore the at least a part of the electronic device from which the deformation is detected by performing the task; and when it is determined that the at least a part of the electronic device from which the deformation is detected is not restored, the processor may perform the task while maintaining the deformation of the at least a part of the electronic device.

In an example embodiment, the processor may detect that the at least a part of the electronic device is deformed to form a predetermined angle using the at least one sensor, and may identify a task performance time which remains until the identified task is completed at a specified timer interval, may determine whether a change rate of the task performance time remaining until the identified task is completed is constant or not, may determine an angle per unit time for restoring the at least a part of the electronic device from which the deformation is detected, when the change rate of the task performance time remaining until the identified task is completed is constant, may restore the at least a part of the electronic device from which the deformation is detected from the predetermined angle at an equiangular velocity, and, when the change rate of the task performance time remaining until the identified task is completed is variable, may restore the at least a part of the electronic device from which the deformation is detected from the predetermined angle at a variable angular velocity.

In an example embodiment, the processor may determine whether the determined angle per unit time is greater than or equal to a specified angle, when the determined angle per unit time is greater than or equal to the specified angle, the processor may restore the at least a part of the electronic device by the determined angle per unit time; and, when the determined angle per unit time is less than the specified angle, may stop restoring the at least a part of the electronic device until the determined angle per unit time is equal to the specified angle, and may restore the at least a part of the electronic device from a time when the determined angle per unit time is equal to the specified angle.

In an example embodiment, after detecting the deformation of the at least a part of the electronic device, the processor may determine whether to restore the at least a part of the electronic device based on whether there is a user input or a movement of the electronic device.

In an example embodiment, the processor may set a performance time of the task as a fixed time based on at least the deformation of the at least a part of the electronic device, or may set the performance time of the task based on at least one of a degree of deformation of the at least a part of the electronic device, a number of times the at least a part of the electronic device is deformed, and a time during which a user contacts the at least a part of the electronic device.

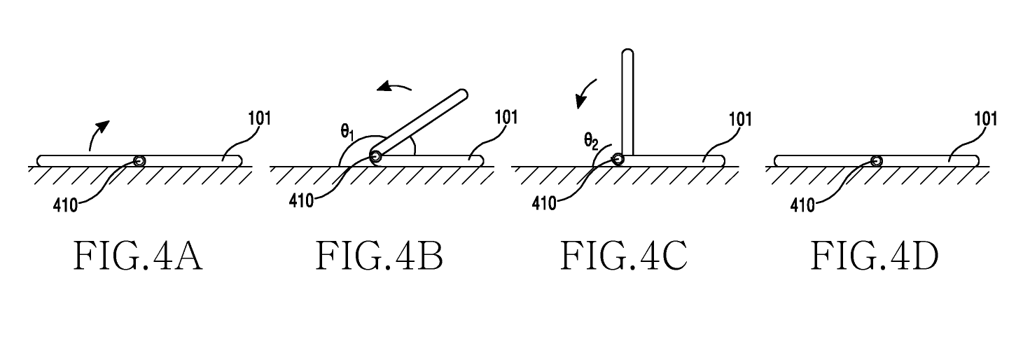

FIGS. 4A, 4B, 4C, 4D, 5A, 5B, 6A and 6B are diagrams illustrating an example method for performing a task according to various example embodiments of the present disclosure.

Referring to FIGS. 4A to 6B, in an example embodiment, the electronic device 101 may be a flexible electronic device 101. For example, the electronic device 101 may be a flexible electronic device having at least one inner configuration, for example, a housing, a display, a substrate including a circuit for driving the electronic device, deformed flexibly (or like paper).

In an example embodiment, the electronic device 101 may be deformed into a bent shape, a folded shape, or a rolled shape. For example, at least a part of the electronic device 101 may be bent by an external pressure (for example, a user input) or inner driving (for example, power supply to an inner configuration which is deformed when power is supplied). In another example, a state in which at least a part of the electronic device 101 is bent by more than a specified angle based on the degree of bending of the electronic device may be defined as a folded state. In still another example, a state in which at least some regions (or areas) of the electronic device 101 are bent by more than designated regions (or areas) may be defined as a rolled state. However, the definition of the deformed shape of the electronic device 101 is not limited to this. For example, the electronic device 101 may be deformed into various shapes having flexibility in addition to the bent (or crooked), folded, or rolled shape.

In an example embodiment, the electronic device 101 may restore the at least deformed part by performing a designated task in the state in which the at least a part of the electronic device 101 is deformed. In an example embodiment, the electronic device 101 may have at least a part thereof deformed by a user input (or a pressure or force). For example, at least a part of the electronic device 101 may be bent, folded, or rolled by a user. In an example embodiment, when a timer function is performed by a user input with at least a part of the electronic device 101 being deformed, the electronic device 101 may restore the at least deformed part of the electronic device 101 by performing a task related to the timer function. For example, as a time set in the timer function passes (or by reflecting the elapsed time), the electronic device 101 may restore the at least deformed part of the electronic device 101.

In an example embodiment, FIGS. 4A to 4D illustrate an example of restoring at least a deformed part of the electronic device 101 by performing a designated task in a state in which the at least a part of the electronic device 101 is bent. In an example embodiment, the electronic device 101 may include a hinge unit 410 comprising a hinge for folding or restoring at least a part of the electronic device 101. For example, the electronic device 101 may have at least a part of the electronic device 101 folded or restored with reference to the hinge unit 410. In an example embodiment, the electronic device 101 may include a plurality of hinge units and may be folded by various angles or restored by the plurality of hinge units. FIGS. 4A to 4D illustrate the electronic device 101 folded in one direction with reference to one hinge unit 410. In another example embodiment, however, when the electronic device 101 includes an additional hinge unit disposed, for example, perpendicularly to the direction of the hinge unit 410 penetrating through the electronic device 101, the electronic device 101 may be folded in a direction perpendicular to the folding direction of the electronic device 101 in FIGS. 4A to 4D. However, this should not be considered as limiting.

In an example embodiment, when at least a part of the electronic device 101 is folded by a predetermined angle by the user as illustrated in FIG. 4B, the electronic device 101 may perform a restoring operation by performing a task designated for restoring.

In an example embodiment, the task designated for the restoring operation may include a task for which a task performance time is specified at the same time when the task is performed (or at the same when the task is started). The task performance time may vary based on a user setting or a task (for example, a type of task, a task characteristic). In another example embodiment, the task designated for the restoring operation may include a task which is scheduled to be completed when the task is started. In still another embodiment, the task designated for the restoring operation may include a task for which a task completion time is estimated (or calculated) when the task is started. For example, the task designated for the restoring operation may include at least one of a task related to a timer function, a task related to an application update, a task related to file transmission, a task related to a file download, a task related to an automatic photographing function of a camera, and a task related to a charging function. However, this should not be considered as limiting. In an example embodiment, the task designated for the restoring operation may be designated by a user input. For example, in the example of a function of executing a music file, the electronic device 101 may endlessly repeat a music file set based on a user setting or may play only a limited number of music files and end the playing. In an example embodiment, when a limited number of music files are set to be played and ended, a task performance time, for example, a time for plying the music file, is specified. Therefore, the playing the limited number of music files may correspond to the task designated for the restoring operation.

In an example embodiment, the electronic device 101 may perform the operation of restoring the at least folded part of the electronic device 101, for example, the operation of unfolding, by performing the task designated for restoring. For example, the electronic device 101 may perform the operation of unfolding the at least folded part of the electronic device 101 based on a time required to perform the task designated for restoring or a performance speed of the task. For example, when the task is started with at least a part of the electronic device 101 being folded by an angle θ₁ as illustrated in FIG. 4B, the at least a part of the electronic device 101 may be unfolded to form an angle θ₂, which is smaller than the angle θ₁, as illustrated in FIG. 4C, as the task performance time passes. In another example, when the task is completed with the at least a part of the electronic device 101 being folded by the angle θ₂ as illustrated in FIG. 4C, the electronic device 101 may be unfolded to be horizontal (or flat) with the ground as illustrated in FIG. 4D.

In an example embodiment, when at least a part of the electronic device 101 is folded while the task designated for restoring is being performed, the electronic device 101 may unfold the at least folded part of the electronic device 101 based on a remaining time of the total task performance time. In another example embodiment, when the electronic device 101 detects that at least a part of the electronic device 101 is folded and determines that it is possible to perform the task designated for restoring, the electronic device 101 may unfold the at least folded part of the electronic device 101 at the same of starting performing the designated task. However, this should not be considered as limiting.

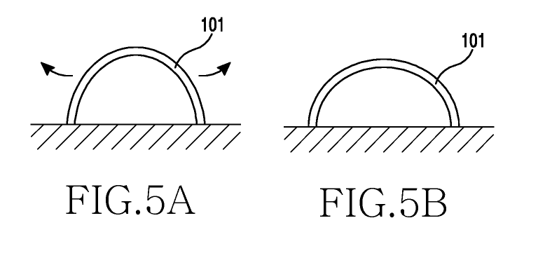

In an example embodiment, FIGS. 5A and 5B illustrate an example of restoring at least a part of the electronic device 101 by performing a designated task in a state in which the at least a part of the electronic device 101 is bent.

For example, as the performance time of the designated task passes in the state in which at least a part of the electronic device 101 is bent as illustrated in FIG. 5A, the at least bent part of the electronic device 101 may be unbent as illustrated in FIG. 5B. FIGS. 5A and 5B illustrate an example of at least a part of the electronic device 101 being bent with reference to the center of the electronic device 101, but this should not be considered as limiting. For example, the at least a part of the electronic device 101 may be bent in various shapes.

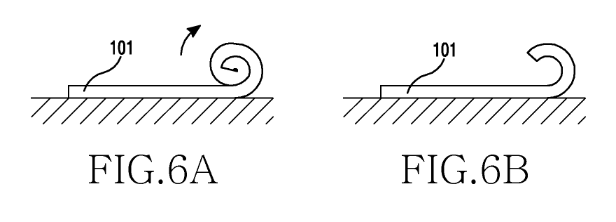

In an example embodiment, FIGS. 6A and 6B illustrate an example of restoring at least a part of the electronic device 101 by performing a designated task in a state in which the at least a part of the electronic device 101 is rolled.

For example, as the performance time of the designated task passes in the state in which at least a part of the electronic device 101 is rolled as illustrated in FIG. 6A, the at least rolled part of the electronic device 101 may be unrolled as illustrated in FIG. 6B. In an example embodiment, the electronic device 101 may further include a receiver (not shown) to receive the at least rolled part of the electronic device 101 when the at least a part of the electronic device 101 is rolled, although it is not illustrated. When the electronic device 101 further includes the receiver, the at least a part of the electronic device 101 received in the receiver may be extended to the outside of the receiver by performing the designated task in the state in which the at least a part of the electronic device 101 is included (or received) in the receiver. However, this should not be considered as limiting.

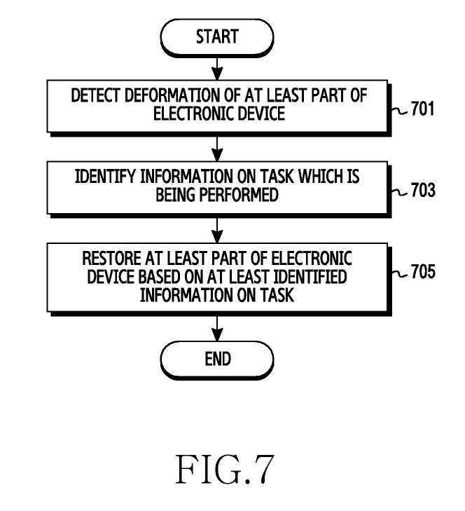

FIG. 7 is a flowchart illustrating an example method for performing a task according to an example embodiment of the present disclosure.

Referring to FIG. 7, in operation 701, the electronic device (for example, the processor 120) may detect a deformation of at least a part of the electronic device 101.

In an example embodiment, the electronic device (for example, the processor 120) may be a flexible electronic device which can have at least a part thereof deformed. For example, the electronic device 101 may include at least one inner configuration having a characteristic of being flexibly deformed (or like paper), for example, a housing, a display, a substrate including a circuit for driving the electronic device, or the like. In an example embodiment, at least a part of the electronic device may be deformed into a bent shape, a folded shape, or a rolled shape.

In an example embodiment, the electronic device (for example, the processor 120) may detect a deformation of at least a part of the electronic device 101 using at least one sensor. In an example embodiment, the at least one sensor for detecting the deformation of the at least a part of the electronic device 101 may include various sensors such as a bend sensor, an acceleration sensor 240E, a gyro sensor 240B, a geomagnetic sensor, or the like. For example, the bend sensor may be disposed on at least one of a front surface and a rear surface of the display 160 of the electronic device, and may be implemented in various forms like an electric resistance type sensor using an electric resistance, a micro optical fiber sensor using a strain rate of an optical fiber, or the like. In another example, the acceleration sensor 240E may detect a deformation of at least a part of the electronic device 101 by measuring acceleration and an acceleration direction of the at least a part of the electronic device 101, which are changed when the at least a part of the electronic device 101 is deformed. In still another example, the gyro sensor 240B may detect a deformation of at least a part of the electronic device 101 by measuring a rotation of the at least a part of the electronic device 101. In yet another example, the geomagnetic sensor may detect a deformation of at least a part of the electronic device 101 by measuring an azimuth of the at least a part of the electronic device 101 using a 2-axis or 3-axis fluxgate. However, the sensor for detecting the deformation of the at least a part of the electronic device 101 is not limited to these sensors, and various sensors may be utilized. For example, the electronic device 101 may detect a deformation of at least a part of the electronic device 101 using an infrared sensor, an ultrasonic sensor, a proximity sensor, or the like.

In an example embodiment, operation 701 of detecting the deformation of the at least a part of the electronic device 101 may further include a process of obtaining information on the deformation of the at least a part of the electronic device 101 (for example, information on the degree of deformation), in addition to the process of detecting the deformation/non-deformation of the at least a part of the electronic device 101. In another example, the process of obtaining the information on the deformation of the at least a part of the electronic device 101 may be included in a process of restoring the at least deformed part of the electronic device 101 in operation 705, and the process of detecting only the deformation/non-deformation of the at least a part of the electronic device 101 20 may be included in the process of detecting the deformation of the at least a part of the electronic device in process 701. However, this should not be considered as limiting.

In operation 703, the electronic device (for example, the processor 120) may identify information on a task which is being performed.

In an example embodiment, the electronic device (for example, the processor 120) may identify information on a task which is being performed in the electronic device 101. For example, the electronic device (for example, the processor 120) may determine whether the task currently performed in the electronic device 101 is a task designated for restoring or not. In an example embodiment, the task designated for the restoring operation may include a task for which a task performance time is specified at the same time when the task is performed (or at the same when the task is started). The task performance time may vary based on a user setting or a task (for example, a type of task, a task characteristic). In another example embodiment, the task designated for the restoring operation may include a task which is scheduled to be completed when the task is started. In still another example embodiment, the task designated for the restoring operation may include a task for which a task completion time is estimated (or calculated) when the task is started. For example, the task designated for the restoring operation may include at least one of a task related to a timer function, a task related to an application update, a task related to file transmission, a task related to a file download, a task related to an automatic photographing function of a camera, and a task related to a charging function. However, this should not be considered as limiting. In an example embodiment, the task designated for the restoring operation may be designated by a user input. For example, in the case of a function of executing a music file, the electronic device 101 may endlessly repeat a music file set based on a user setting or may play only a limited number of music files and end the playing. When a limited number of music files are set to be played and ended, a task performance time, for example, a time for plying the music file, is specified. Therefore, the playing the limited number of music files may correspond to the task designated for the restoring operation.

In another example embodiment, the electronic device (for example, the processor 120) may determine whether the electronic device 101 is in a state in which the task designated for restoring can be performed. For example, the electronic device (for example, the processor 120) may determine whether the electronic device 101 is in a state in which the task designated for restoring is set to be performed in response to an input, for example, a deformation of the electronic device 101. For example, in the case of the timer function, when time of the timer is set, the electronic device (for example, the processor 120) may determine that the electronic device 101 is in the state in which the task designated for restoring can be performed. In another example, in the case of the file transmission, when a file to be transmitted by the user and a device (or location) to receive the file are selected, the electronic device (for example, the processor 120) may determine that the electronic device 101 is in the state in which the designated task can be performed. However, this should not be considered as limiting.

In an example embodiment, when it is determined that the electronic device 101 is in the state in which the task designated for restoring can be performed, the electronic device (for example, the processor 120) may start performing the task designated for restoring (or may trigger to perform the task designated for restoring). For example, when it is determined that time of the timer is set, the electronic device (for example, the processor 120) may start performing the task to let the set time pass as the timer function is executed. In another example, when it is determined that the file to be transmitted by the user and the device (or location) to receive the file are selected, the electronic device (for example, the processor 120) may start performing the task to transmit the file as the file transmission is executed.

In another example, when the electronic device (for example, the processor 120) determines that the electronic device 101 is in the state in which the task designated for restoring can be performed, the electronic device 101 may start performing the designated task by receiving a user's input (for example, a touch input). However, this should not be considered as limiting

In an example embodiment, when it is determined that a plurality of tasks are performed in the electronic device (for example, the processor 120), the electronic device 101 may identify information on a main task from among the plurality of tasks. For example, when the plurality of tasks are being performed in the electronic device 101, the electronic device 101 may identify information on a task related to a function (for example, an application function or the like) which is being executed in a foreground). However, this should not be considered as limiting.

In operation 705, the electronic device (for example, the processor 120) may restore the at least a part of the electronic device 101 based on at least the identified information on the task.

In an example embodiment, when it is determined that the task which is being performed in the electronic device 101 is not the task designated for restoring in operation 703, the electronic device (for example, the processor 120) may continue to perform the task while maintaining the deformation of the at least a part of the electronic device (for example, the processor 120). In another example, when it is determined that the task which is being performed in the electronic device 101 is the task designated for restoring in operation 703, the electronic device (for example, the processor 120) may restore the at least deformed part of the electronic device 101 by performing the task.

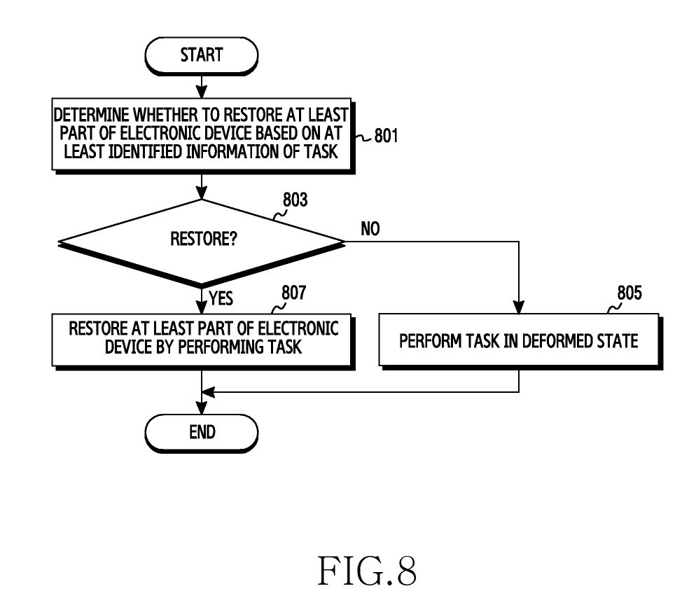

The process of restoring the at least deformed part of the electronic device 101 by performing the task will be described in greater detail below with reference to FIGS. 8 to 13B.

FIG. 8 is a flowchart illustrating an example method for restoring at least a part of the electronic device 101 according to an example embodiment of the present disclosure.

Referring to FIG. 8, in operation 801, the electronic device (for example, the processor 120) may determine whether to restore at least a part of the electronic device 101 based on identified information on a task.

In an example embodiment, when it is determined that a task currently performed in the electronic device 101 is a task designated for restoring, the electronic device (for example, the processor 120) may determine to restore the at least deformed part of the electronic device 101. For example, when it is determined that at least one of a task related to a timer function, a task related to an application update function, a task related to a file transmission function, a task related to a file download function, a task related to an automatic photographing function of a camera, and a task related to a charging function is being currently performed, the electronic device (for example, the processor 120) may determine to restore the at least deformed part of the electronic device 101. However, the task for determining to restore is not limited to the above-mentioned examples.

In another example embodiment, when it is determined that the task designated for restoring can be performed in the electronic device 101 and the task designated for restoring is started, the electronic device (for example, the processor 120) may determine to restore the at least deformed part of the electronic device 101.

In an example embodiment, operation 801 of determining whether to restore the at least a part of the electronic device 101 may include a process of, after detecting a deformation of at least a part of the electronic device 101, determining whether to restore the at least a part of the electronic device 101 based on whether there is a user input or a movement of the electronic device 101. 10 For example, when a deformation of at least a part of the electronic device 101 is detected and it is determined that the performed task is the task designated for restoring, the electronic device (for example, the processor 120) may determine not to restore the at least a part of the electronic device 101 in response to a user's input (for example, a touch input, a movement of the electronic device 101, 15 or the like) or a movement of the electronic device 101 being detected. In an example embodiment, the user's input or the movement of the electronic device 101 being detected may indicate a case in which the user deforms at least a part of the electronic device 101 for the purpose of simply holding the electronic device 101. In another example embodiment, the user's input or the movement of the electronic device 101 being detected may indicate a case in which at least a part of the electronic device 101 is deformed while a function other than performing the task for restoring is being performed (or is deformed for other purposes). For example, the user's input being detected may indicate a case in which a user's input for creating a message is detected when at least a part of the electronic device 101 is deformed. In another example, the movement of the electronic device 101 being detected may indicate a case in which the user deforms, for example, bends at least a part of the electronic device 101 in order to move the at least a part of the electronic device 101 closer to user's ear while performing the telephony function of the electronic device 101.

When the electronic device (for example, the processor 120) does not determine to restore the at least a part of the electronic device 101 in operation 803, the electronic device (for example, the processor 120) may perform the task with the at least a part of the electronic device 101 being deformed in operation 805. For example, when it is determined that the task performed in the electronic device 101 is not the task designated for restoring, the electronic device (for example, the processor 120) may perform the task with the at least a part of the electronic device 101 being deformed. In another example, when there is a user input or a movement of the electronic device 101 within a specified threshold time after the deformation of the at least a part of the electronic device 101 was detected, the electronic device (for example, the processor 120) may continue performing the current task or perform a function corresponding to the user input or the movement of the electronic device 101 with the at least a part of the electronic device 101 being deformed. However, this should not be considered as limiting.

When the electronic device (for example, the processor 120) determines to restore the at least a part of the electronic device 101 in operation 803, the electronic device (for example, the processor 120) may restore the at least a part of the electronic device 101 by performing the task in operation 807.

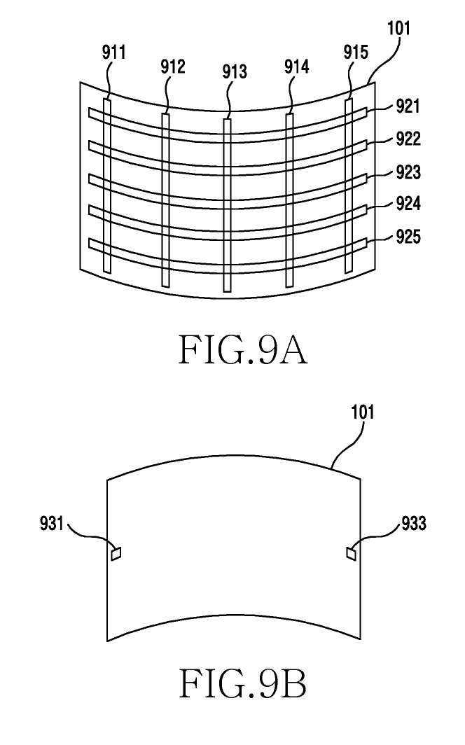

In an example embodiment, the electronic device (for example, the processor 120) may obtain information on the deformation of the at least a part of the electronic device 101, for example, information on an angle which is formed by the deformation of the at least a part of the electronic device 101. A method for obtaining the information on the deformation of the at least a part of the electronic device 101 will be described in greater detail below with reference to FIGS. 9A and 9B.

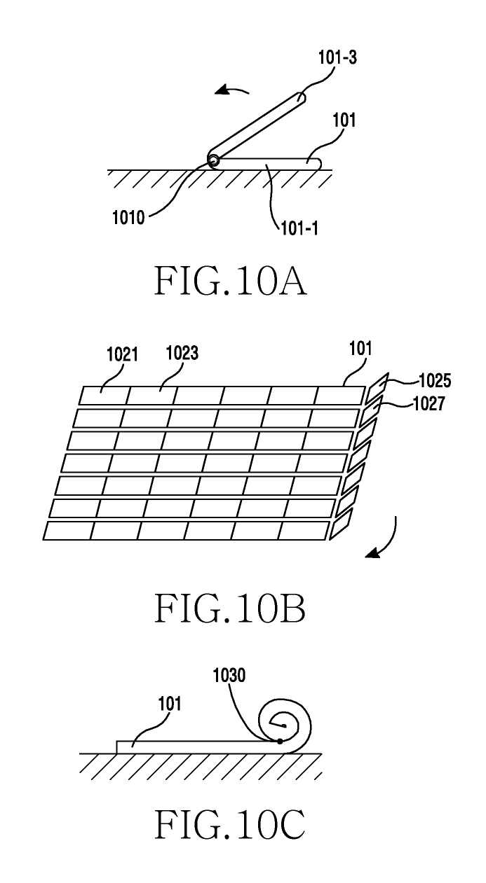

In an example embodiment, by performing the task designated for restoring, the electronic device (for example, the processor 120) may restore the at least deformed part of the electronic device 101. The operation of restoring the at least deformed part of the electronic device 101 by performing the task will be described in greater detail below with reference to FIGS. 10A to 10C.

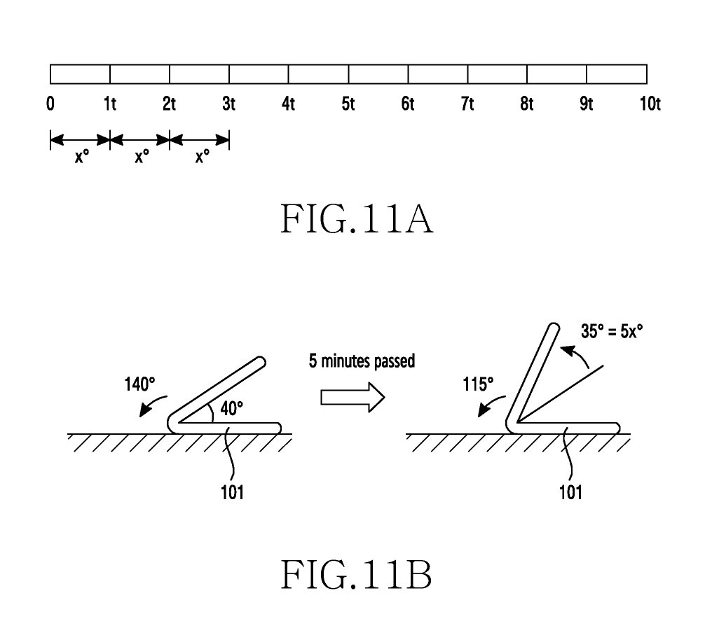

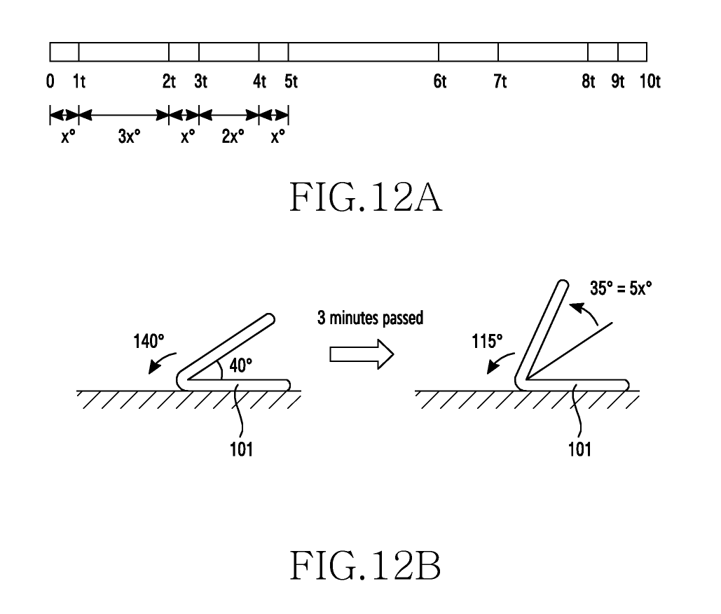

In an example embodiment, the electronic device (for example, the processor 120) may identify a remaining performance time of the designated task periodically while restoring the at least deformed part of the electronic device 101. In an example embodiment, the electronic device (for example, the processor 120) may periodically provide the result of performing the designated task or a notification on the completion of the task in various ways. For example, while performing the task related to the timer function or when completing the task, the electronic device (for example, the processor 120) may provide a notification on the passing of time at specified intervals (for example, every one minute). The electronic device (for example, the processor 120) may output at least one of a notification window display, a sound, haptic feedback, and light to provide the notification. However, this should not be considered as limiting. In an example embodiment, when at least a part of the electronic device 101 is deformed to form a certain angle, the electronic device (for example, the processor 120) may restore the at least deformed part of the electronic device 101 from the formed angle at an equiangular velocity or a variable angular velocity, according to whether a change rate of the remaining performance time of the task is constant or not. The operation of restoring the at least deformed part of the electronic device 101 from the formed angle at the equiangular velocity or the variable angular velocity based on whether the change rate of the remaining performance time of the task is constant or not will be described in greater detail below with reference to FIGS. 11A and 11B and FIGS. 12A and 12B.

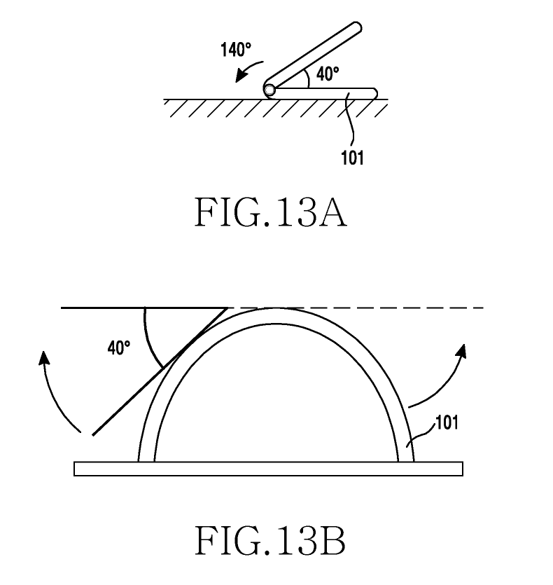

In an example embodiment, in a state in which at least a part of the electronic device 101 is deformed to form a certain angle, when an angle restored per unit time is less than or equal to a specified angle, the electronic device 101 may stop restoring until the angle restored per unit time is equal to the specified angle, and may restore by the specified angle per unit time from the time when the angle restored per unit time is equal to the specified angle. The operation of stopping restoring during a predetermined time and then restoring by comparing the angle restored per unit time and the specified angle per unit time will be described in greater detail below with reference to FIGS. 13A and 13B.

FIGS. 9A and 9B are diagrams illustrating an example method for restoring at least a part of the electronic device 101 according to an example embodiment of the present disclosure. FIGS. 9A and 9B are diagrams illustrating an example process of the electronic device (for example, the processor 120) obtaining deformation information of at least a part of the electronic device 101.

As illustrated in FIG. 9A, the electronic device 101 may include a plurality of bend sensors 911 to 915 and 921 to 925 for obtaining deformation information of at least a part of the electronic device 101. In an example embodiment, each of the plurality of bend sensors 911 to 915 and 921 to 925 of FIG. 9A may be implemented using, for example, a resistance type sensor. However, this should not be considered as limiting. For example, each of the plurality of bend sensors 911 to 915 and 921 to 925 may be implemented using a micro optical fiber sensor using a strain rate of an optical fiber.

In an example embodiment, the electronic device (for example, the processor 120) may obtain deformation information of at least a part of the electronic device 101 using the plurality of bend sensors 911 to 915 and 921 to 925. In an example embodiment, information on a deformation of at least a part of the electronic device 101 may include information on at least one of a location of a deformed part, a degree of deformation (for example, a deformation angle), a direction of deformation, a deformation speed, the number of times of deformation, the number of deformed locations. However, this should not be considered as limiting.

In an example embodiment, when the electronic device 101 is bent such that its center faces downwards with reference to both right and left edges of the electronic device 101, tension may be applied to the bend sensors 921 to 925 arranged in a horizontal direction. In an example embodiment, the bend sensors 921 to 925 arranged in the horizontal direction may obtain tension applied to the bend sensors 921 to 925 arranged in the horizontal direction, and may output resistance values based on the obtained tension. In one embodiment, the electronic device (for example, the processor 120) may obtain information on at least one of a location of a deformed part, a degree of deformation (for example, a deformation angle), a deformation speed, the number of times of deformation, and the number of deformed locations based on the resistance values output from the bend sensors 921 to 925 arranged in the horizontal direction. For example, the electronic device (for example, the processor 120) may obtain information on a location of a deformed part of the electronic device 101, a degree of deformation (for example, a deformation angle), and the number of deformed locations based on the sizes of the resistance values output from the bend sensors 921 to 925 arranged in the horizontal direction. In another example, the electronic device (for example, the processor 120) may obtain information on a direction of deformation based on signs of the resistance values output from the bend sensors 921 to 925 arranged in the horizontal direction. In still another example, when at least a part of the electronic device 101 is continuously deformed, the electronic device (for example, the processor 120) may obtain information on a deformation speed and the number of times of deformation based on information on a difference in the resistance values continuously output by the plurality of bend sensors. Although FIG. 9A illustrates the electronic device 101 bent such that its center faces downward with reference to both right and left edges in an example embodiment, it would be apparent to a person skilled in the art that the information on the deformation is obtained in the same way or a similar way when the electronic device 101 is bent such that its center faces downward or upwards with reference to both upper and lower edges.

In an example embodiment, as illustrated in FIG. 9B, the electronic device 101 may include a plurality of acceleration sensors 931 and 933 to obtain information on a deformation of at least a part of the electronic device 101. In an example embodiment, the plurality of acceleration sensors 931 and 933 may output gravity acceleration which changes in response to at least a part of the electronic device 101 being bent. In one embodiment, the electronic device 101 may obtain information on a pitch angle and a roll angle based on at least information on the gravity acceleration outputted by the plurality of acceleration sensors 931 and 933.

Although FIGS. 9A and 9B illustrate the bend sensors and the acceleration sensors 240E as sensors for obtaining the information on the deformation of the at least a part of the electronic device 101, this should not be considered as limiting. For example, the electronic device (for example, the processor 120) may obtain the information on the deformation of the at least a part of the electronic device 101 using various sensors such as a gyro sensor 240B and a geomagnetic sensor. For example, the electronic device 101 may obtain the information on the deformation of the at least a part of the electronic device 101 by measuring the rotation of the at least a part of the electronic device 101 using the gyro sensor 240B. In another example, the electronic device (for example, the processor 120) may detect the deformation of the at least a part of the electronic device 101 by measuring the azimuth of the at least a part of the electronic device 101 using a 2-axis or 3-axis fluxgate using the geomagnetic sensor. In still another example, the electronic device 101 may obtain the information on the deformation of the at least a part of the electronic device 101 using an infrared sensor, an ultrasonic sensor 240M, or a proximity sensor 240G.

FIGS. 9A and 9B illustrate an example in which at least a part of the electronic device 101 is bent, but this should not be considered as limiting. For example, when at least a part of the electronic device 101 is folded, information on a deformation may be obtained in the same way or similar way as or to that of the example embodiment of FIGS. 9A and 9B.

In an example embodiment, when at least a part of the electronic device 101 is rolled, the electronic device (for example, the processor 120) may obtain information on at least one of the location of the rolled part of the electronic device 101 and roll information (for example, the area (or size) of the rolled part). For example, when the electronic device 101 includes a plurality of bend sensors, the electronic device 101 may obtain the information of at least one of the location of the rolled part and the roll information (for example, the area (or size) of the rolled part) by determining a difference between a resistance value outputted from the bend sensor arranged in the rolled part of the electronic device 101 and a resistance value outputted from the bend sensor arranged in the unrolled part (for example, a flat part). In another example, the electronic device (for example, the processor 120) may obtain the information on at least one of the location of the rolled part of the electronic device 101 and the roll information (for example, the area (or size) of the rolled part) using a line or an area where the rolled part of the electronic device 101 is brought into contact with the unrolled part. For example, the electronic device (for example, the processor 120) may obtain the information on at least one of the location of the rolled part and the roll information (for example, the area (or size) of the rolled part) by detecting the line where the rolled part of the electronic device 101 is brought into contact with the unrolled part, and then distinguishing between the rolled part and the unrolled part with reference to the detected line.

FIGS. 10A, 10B and 10C are diagrams illustrating an example method for restoring at least a part of the electronic device 101 according to another example embodiment of the present disclosure.

In an example embodiment, the electronic device (for example, the processor 120) may restore at least a deformed part of the electronic device 101 by performing a task designated for restoring.

For example, FIG. 10A illustrates a state in which a part 101-1 of the electronic device 101 is laid horizontally on the ground and the other part 101-3 of the electronic device 101 is folded with reference to a hinge unit 1010. In an example embodiment, by performing a designated task in the electronic device 101, the electronic device (for example, the processor 120) may restore (or rotate) the part 101-3 of the electronic device 101 using the hinge unit 1010 in the direction of an arrow. In another example embodiment, the electronic device (for example, the processor 120) may restore (or rotate) the part 101-3 of the electronic device 101 in the direction of the arrow based on a performance time of the designated task. In still another example embodiment, the electronic device (for example, the processor 120) may restore (or rotate) the part 101-3 of the electronic device 101 in the direction of the arrow based on a performance speed of the designated task (or a change rate of a remaining performance time of the task) which is measured periodically (for example, every 1 minute) in the electronic device 101. However, this should not be considered as limiting.

In an example embodiment, FIG. 10A illustrates an example in which the electronic device 101 includes one hinge unit 101 and is deformed or restored with reference to the hinge unit 1010. However, when the electronic device 101 includes a plurality of hinge units, the electronic device 101 may be deformed or restored in various directions (or by various angles).

In another example, the electronic device 101 may include a configuration (or a driving unit or an actuator) to deform or restore a part of the electronic device 101. For example, the configuration for deforming or restoring a part of the electronic device 101 may include an element or material which contracts or expands based on a power supplied from an external power source. For example, the configuration for deforming or restoring a part of the electronic device 101 may be implemented using an ionic polymer-metal composite or shape memory alloys which contract or expand according to power supply from the external power source. However, this should not be considered as limiting.

In an example embodiment, FIG. 10B illustrates the electronic device 101 in which a configuration for deforming or restoring a part of the electronic device 101 includes a plurality of cells 1021, 1023, 1025 and 1027. In an example embodiment, at least one cell 1025, 1027 of the plurality of cells 1021, 1023, 1025 and 1027 may be deformed or restored in the direction of an arrow based on power supply as illustrated in FIG. 10B. In an example embodiment, the electronic device 101 may restore the at least deformed part of the electronic device 101 by adjusting voltage supply to the at least one deformed cell 1025, 1027 from among the plurality of cells 1021, 1023, 1025 and 1027 of the electronic device 101 by performing a task designated for restoring. In another example embodiment, the electronic device 101 may restore the at least deformed part of the electronic device 101 by adjusting voltage supply (or a level of a voltage) to the at least one deformed cell 1025, 1027 from among the plurality of cells 1021, 1023, 1025 and 1027 of the electronic device 101 based on the performance time of the designated task. In still another example embodiment, the electronic device (for example, the processor 120) may restore the at least deformed part of the electronic device 101 by adjusting voltage supply to the at least one deformed cell 1025, 1027 from among the plurality of cells 1021, 1023, 1025 and 1027 of the electronic device 101 based on the performance speed of the designated task which is measured in the electronic device 101 periodically (for example, every 1 minute). However, this should not be considered as limiting.

In an example embodiment, FIG. 10C illustrates a view explaining a process of the electronic device (for example, the processor 120) restoring at least a part of the electronic device 101 by performing a task designated for restoring in a state in which the at least a part of the electronic device is rolled. When at least a part of the electronic device 101 is rolled as illustrated in FIG. 10C, the electronic device (for example, the processor 120) may obtain information on at least one of the location of the rolled part of the electronic device 101 and roll information (for example, an area (or size) of the rolled part), that is, information on the at least deformed part of the electronic device 101. For example, the electronic device (for example, the processor 120) may obtain the information on at least one of the location of the rolled part of the electronic device 101 and the roll information (for example, the area (or size) of the rolled part) using a line connecting points 1030 where the rolled part and the unrolled part of the electronic device 101 are brought in contact with each other (or with reference to the line). In an example embodiment, the electronic device (for example, the processor 120) may restore the at least rolled part of the electronic device 101 by performing the task designated for restoring. For example, the electronic device 101 may include the hinge unit 1010 of FIG. 10A or the configuration for deforming or restoring a part of the electronic device 101 as illustrated in FIG. 10B. The electronic device (for example, the processor 120) may restore the at least rolled part of the electronic device 101 by performing the task using the hinge unit 1010 or the configuration for deforming or restoring a part of the electronic device 101. In another example, the electronic device (for example, the processor 120) may restore the at least rolled part of the electronic device 101 based on the performance time of the designated task in the electronic device 101 using the hinge unit 1010 or the configuration for deforming or restoring a part of the electronic device 101. In still another example, the electronic device (for example, the processor 120) may restore the at least rolled part of the electronic device 101 based on the performance speed of the designated task, which is measured in the electronic device 101 periodically (for example, every 1 minute), using the hinge unit 1010 or the configuration for deforming or restoring a part of the electronic device 101.

FIGS. 11A, 11B, 12A, 12B, 13A and 13B are diagrams illustrating an example method for restoring at least a part of the electronic device 101 according to still another example embodiment of the present disclosure.

In an example embodiment, the electronic device (for example, the processor 120) may adjust a degree of restoring the at least deformed part of the electronic device 101 based on whether a task performance time remaining until the task is completed is regularly (or equally) changed (or whether a change rate of the task performance time is constant or not), while performing the task designated for restoring.

For example, when the task performance time remaining until the task is completed is regularly changed at a time interval of 1t as illustrated in FIG. 11A, the electronic device (for example, the processor 120) may restore the at least deformed part of the electronic device 101 by an angel of x° at a time (for example, at an equiangular velocity). For example, when a part of the electronic device 101 is folded by 140° as illustrated in FIG. 11B and the total performance time of the task is determined (or estimated or scheduled) as 20 minutes, the electronic device (for example, the processor 120) may restore the at least folded part of the electronic device 101 by an angle of 7° per unit time, for example, per minute. For example, when 5 minutes of the task performance time passes as illustrated in FIG. 11B, the electronic device (for example, the processor 120) may restore the at least folded part of the electronic device 101 by an angle of 35°. In an example embodiment, the example in which the task performance time remaining until the task is completed is regularly changed while the task is being performed may be an example in which the task related to the timer function is performed.

In another example, FIG. 12A illustrates an example in which the task performance time remaining until the task is completed is variably changed. For example, when the task related to the file transmission function is performed, a file transmission end time (or a file transmission speed or the like) may be changed variably based on a factor such as a communication environment or the like, and accordingly, the time required to perform the task related to the file transmission is also variable until the task related to the file transmission is completed. In an example embodiment, the electronic device (for example, the processor 120) may measure (or calculate) the remaining task performance time periodically (or at a regular time interval), and may restore the at least deformed part of the electronic device 101 based on the measured remaining task performance time. For example, as illustrated in FIG. 12A, the electronic device (for example, the processor 120) may restore the at least deformed part of the electronic device 101 by an angle of x° from time 0 until time 1t, consider the remaining task performance time at time 1t, and restore the at least deformed part of the electronic device 101 by an angle of 3x° from time 1t until time 2t. For example, the electronic device (for example, the processor 120) may consider the remaining task performance time at times 2t, 3t, and 4t, and may restore the at least deformed part of the electronic device 101 by the angle of x° from time 2t until time 3t, by an angle of 2x° from time 3t until time 4t, and by the angle of x° from time 4t until time 5t. However, this should not be considered as limiting. In an example embodiment, when at least a part of the electronic device 101 is folded by 140° and the total performance time of the task is determined (estimated or scheduled) as 20 minutes as illustrated in FIGS. 11A and 11B, and when 3 minutes of the task performance time passes, the electronic device (for example, the processor 120) may restore the at least folded part of the electronic device 101 by 35° corresponding to 5x°.

In an example embodiment, FIGS. 13A and 13B illustrate an example of the electronic device (for example, the processor 120) restoring the at least deformed part of the electronic device 101 by determining whether a restoring angle determined per unit time is greater than or equal to a specified angle or not.

For example, when a specified angle is an angle of 5° per minute, at least a part of the electronic device 101 is folded by 140°, the task performance time is determine as 20 minutes in FIG. 13A, the electronic device (for example, the processor 120) may determine a restoring angle per minute as 7°. The electronic device (for example, the processor 120) may determine that the determined restoring angle per minute, 7°, is greater than the specified angle 5°. When the determined restoring angle per minute is greater than the specified angle, the electronic device 101 may restore the at least folded part of the electronic device 101 by the determined restoring angle per minute.

In another example, when the specified angle is an angle of 5° per minute, at least a part of the electronic device 101 is bent by 40°, the task performance time is determined as 20 minutes in FIG. 13B, the electronic device 101 may determine a restoring angle per minute as 2°. The electronic device (for example, the processor 120) may determine that the determined restoring angle per minute, 2°, is less than the specified angle 5°. In an example embodiment, when the determined restoring angle per minute is less than the specified angle, the electronic device (for example, the processor 120) may stop restoring until the restoring angle per minutes is equal to the specified angle. In an example embodiment, in the state in which the electronic device (for example, the processor 120) stops restoring, when the restoring angle per minute is equal to the specified angle, the electronic device (for example, the processor 120) may restore the at least deformed part of the electronic device 101 by the specified angle per minute. In an example embodiment, the electronic device (for example, the processor 120) may determine a time at which the restoring angle per minute is equal to the specified angle according to following Equation 1:

$$\frac{a}{t - k} = c \qquad Equation 1$$

where a is a deformation angle, t is the total task performance time, c is a specified angle per unit time, and k is a time at which the restoring angle per minute is equal to the specified angle.

For example, when at least a part of the electronic device 101 is deformed by 40°, the total task performance time is 20 minutes, and the specified angle per minute is 5°, the electronic device 101 may determine the time at which the restoring angle per minute is equal to the specified angle as 12 minutes. In an example embodiment, the electronic device (for example, the processor 120) may stop restoring the at least deformed part of the electronic device 101 during 8 minutes out of the total task performance time of 20 minutes, and may restore the at least deformed part of the electronic device 101 by 5° per minute during remaining 12 minutes. In an example embodiment, the electronic device (for example, the processor 120) may stop restoring when the angle restored per unit time is less than the specified angle, and may restore by the specified angle per unit time from the time when the restoring angle is greater than or equal to the specified angle, such that the operation of restoring the at least deformed part of the electronic device 101 by performing the task designated for restoring is visually provided to the user.

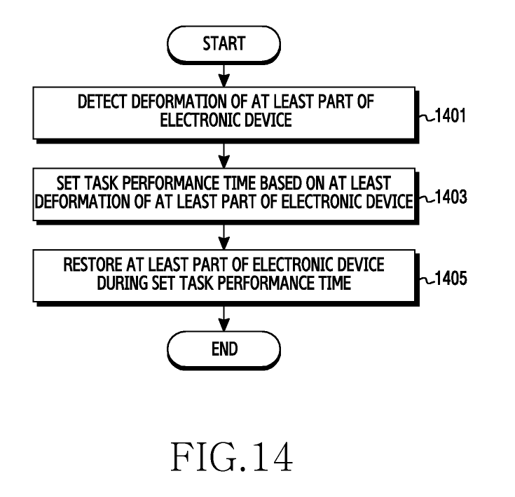

FIG. 14 is a flowchart illustrating an example method for performing a task according to another example embodiment of the present disclosure.

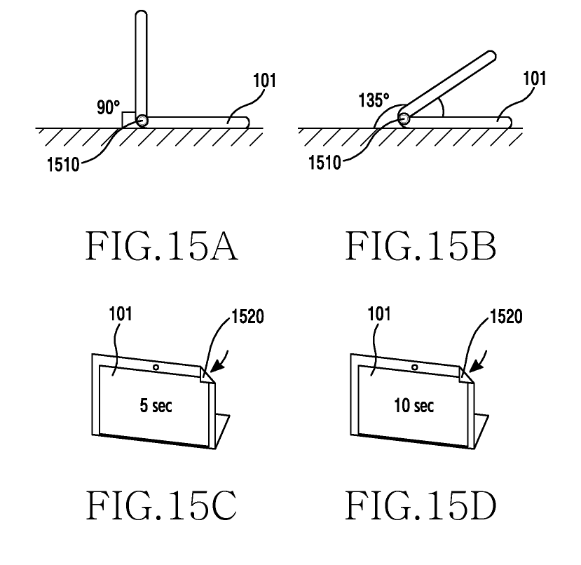

FIGS. 15A, 15B, 15C and 15D are diagrams illustrating an example method for performing a task according to another example embodiment of the present disclosure.

Referring to FIGS. 14 to 15D, in operation 1401, the electronic device (for example, the processor 120) may detect a deformation of at least a part of the electronic device 101.

In an example embodiment, at least a part of the electronic device 101 may be deformed into a bent shape, a folded shape, or a rolled shape.

In an example embodiment, the electronic device (for example, the processor 120) may detect a deformation of at least a part of the electronic device 101 using at least one sensor. In an example embodiment, the at least one sensor for detecting the deformation of the at least a part of the electronic device 101 may include various sensors such as a bend sensor, an acceleration sensor 240E, a gyro sensor 240B, a geomagnetic sensor, or the like. For example, the bend sensor may be disposed on at least one of a front surface and a rear surface of the display 160 of the electronic device, and may be implemented in various forms like an electric resistance type sensor using an electric resistance, a micro optical fiber sensor using a strain rate of an optical fiber, or the like. In another example, the acceleration sensor 240E may detect a deformation of at least a part of the electronic device 101 by measuring acceleration and an acceleration direction of the at least a part of the electronic device 101, which are changed when the at least a part of the electronic device 101 is deformed. In still another example, the gyro sensor 240B may detect a deformation of at least a part of the electronic device 101 by measuring a rotation of the at least a part of the electronic device 101. In yet another example, the geomagnetic sensor may detect a deformation of at least a part of the electronic device 101 by measuring an azimuth of the at least a part of the electronic device 101 using a 2-axis or 3-axis fluxgate. However, the sensor for detecting the deformation of the at least a part of the electronic device 101 is not limited to these sensors, and various sensors may be utilized. For example, the electronic device (for example, the processor 120) may detect a deformation of at least a part of the electronic device 101 using an infrared sensor, an ultrasonic sensor 240M, a proximity sensor 240O or the like.

In operation 1403, the electronic device (for example, the processor 120) may set a performance time of a task designated for restoring based on the deformation of the at least a part of the electronic device 101.

In an example embodiment, the task designated for restoring may include a task for which a task performance time can be set by the user, such as a task related to a timer function or a task related to an automatic photographing function of a camera. However, this should not be considered as limiting.

In an example embodiment, when at least a part of the electronic device 101 is deformed, the electronic device (for example, the processor 120) may set the task performance time as a fixed performance time. For example, in the case of the task related to the automatic photographing function of the camera, when at least a part of the electronic device 101 is deformed, the electronic device (for example, the processor 120) may set the task performance time for automatic photographing to 10 seconds as a fixed value regardless of the degree of deformation (for example, a deformation angle). In another example, in the case of the task related to the timer function, when at least a part of the electronic device 101 is deformed, the electronic device (for example, the processor 120) may set the task performance time for the timer function to 3 minutes as a fixed value regardless of the degree of deformation (for example, a deformation angle). However, this should not be considered as limiting.

In another example embodiment, the electronic device (for example, the processor 120) may set the task performance time based on the degree of deformation (for example, a deformation angle) of at least a part of the electronic device 101. For example, in the case of the task related to the timer function, the electronic device (for example, the processor 120) may set the task performance time for the timer function based on the degree of deformation of at least a part of the electronic device 101, for example, a bending angle of at least a part of the electronic device 101, a folding angle of at least a part of the electronic device 101, or a size of an area of at least a rolled part of the electronic device 101. In another example, the electronic device (for example, the processor 120) may set the task performance time for the timer function in proportion to a bending angle of at least a part of the electronic device 101, a folding angle of at least a part of the electronic device 101, or a size of an area of at least a rolled part of the electronic device 101. For example, when at least a part of the electronic device 101 is folded by 90° with reference to a hinge unit 1510 as illustrated in FIG. 15A, the electronic device (for example, the processor 120) may set the task performance time for the timer function to 10 minutes, and, when at least a part of the electronic device 101 is folded by 135° with reference to the hinge unit 1510 as illustrated in FIG. 15B, the electronic device (for example, the processor 120) may set the task performance time for the timer function to 15 minutes.

In still another embodiment, the electronic device (for example, the processor 120) may set the task performance time based on the number of times at least a part of the electronic device 101 is deformed. In an example embodiment, the electronic device (for example, the processor 120) may detect the number of times at least a part of the electronic device 101 is deformed. For example, the electronic device (for example, the processor 120) may detect the number of times at least a part of the electronic device 101 is continuously deformed. For example, when the electronic device 101 laid horizontally on the ground is continuously rotated by 90° with reference to the hinge unit 1510 as illustrated in FIG. 15A, stops being rotated during a time shorter than a threshold value in the rotation state by 90°, and then is continuously rotated by 135° with reference to the hinge unit 1510, the electronic device (for example, the processor 120) may determine that the electronic device 101 is deformed two times. In an example embodiment, the electronic device (for example, the processor 120) may set the task performance time in proportion to the number of times at least a part of the electronic device 101 is deformed. For example, when at least a part of the electronic device 101 is deformed one time, the electronic device (for example, the processor 120) may set the task performance time to 5 minutes, and, when at least a part of the electronic device 101 is deformed two times, the electronic device (for example, the processor 120) may set the task performance time to 10 minutes.

In still another example embodiment, when a least a part of the electronic device 101 is deformed by the user contacting (or touching) at least a part of the electronic device 101, the electronic device (for example, the processor 120) may set the task performance time based on a time during which the user contacts the electronic device 101. For example, when the user contacts (or touches) at least a part 1520 of the electronic device 101 for 5 seconds and then the at least a part 1520 of the electronic device 101 is folded by the contacting force as illustrated in FIG. 15C, the electronic device (for example, the processor 120) may set the performance time of the task related to the automatic photographing function of the camera (for example, a function of photographing after a set time) to 5 seconds. In another example, when the user contacts (or touches) the at least a part 1520 of the electronic device 101 for 10 seconds and then the at least a part 1520 of the electronic device 101 is folded by the contacting force as illustrated in FIG. 15D, the electronic device (for example, the processor 120) may set the performance time of the task related to the automatic photographing function of the camera (for example, a function of photographing after a set time) to 10 seconds. However, this should not be considered as limiting.

In an example embodiment, when the task performance time is set according to the degree of deformation of at least a part of the electronic device 101, the number of times at least a part of the electronic device is deformed, or a time during which the user contacts the electronic device 101, the electronic device (for example, the processor 120) may display the task performance time which increases or is reduced based on the degree of deformation, the number of times of deformation, or the contact time. For example, comparing FIGS. 15C and 15D, when the user intends to set the task performance time to 10 seconds by contacting the electronic device 101 during 10 seconds, the electronic device (for example, the processor 120) may display the task performance time of 5 seconds corresponding to the contact time of 5 seconds at the time when the user contacts the electronic device 101 during 5 seconds, and may display the task performance time of 10 seconds corresponding to the contact time of 10 seconds at the time when the user contacts the electronic device 101 during 10 seconds. However, this should not be considered as limiting.

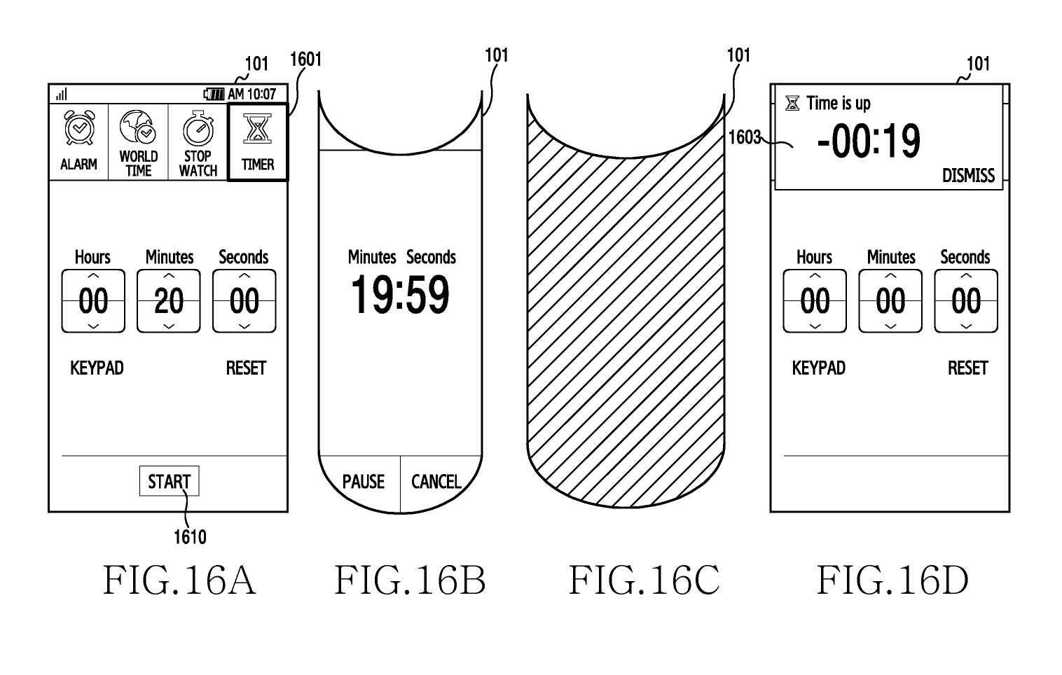

In operation 1405, the electronic device (for example, the processor 120) may restore at least part of the electronic device 101 during the set task performance time. FIGS. 16A, 16B, 16C and 16D are diagrams illustrating an example method for performing a task related to a timer function according to an example embodiment of the present disclosure.

FIG. 16A illustrates a screen for executing a timer function. For example, the electronic device (for example, the processor 120) may display the screen for performing the timer function which is displayed by receiving a user input of selecting a button 1601 for performing the timer function from among the plurality of functions. In an example embodiment, the electronic device (for example, the processor 120) may set a task performance time related to the timer function based on at least a user's touch input. In another example embodiment, the electronic device (for example, the processor 120) may detect a deformation of at least a part of the electronic device 101 and set the task performance time related to the timer function based on the deformation of the at least a part of the electronic device 101. For example, the electronic device (for example, the processor 120) may set the task performance time related to the timer function as a fixed time based on the deformation of the at least a part of the electronic device 101, or may set the task performance time related to the timer function based on at least the degree of deformation of the at least a part of the electronic device 101, the number of times that the at least a part of the electronic device 101 is deformed, or a time during which the user contacts the electronic device 101.

In an example embodiment, the electronic device (for example, the processor 120) may start performing the task related to the timer function based on various inputs. For example, the electronic device (for example, the processor 120) may start performing the task related to the timer function by receiving a user's touch input on a start button 1610. In another example, the electronic device (for example, the processor 120) may start performing the task related to the timer function when detecting a deformation of at least a part of the electronic device 101. For example, in FIG. 16A, the electronic device (for example, the processor 120) may determine that the task related to the timer function is a task designated for restoring, for example, a task for which a task performance time is specified at the same time when the task is performed (or the task is started). The electronic device (for example, the processor 120) may determine that the task related to the timer function is a task designated for restoring, and that a state in which the task performance time for the timer function is set as shown in FIG. 16A is a state in which the task can be performed. When it is determined that the task can be performed, the electronic device (for example, the processor 120) may start performing the task related to the timer function in response to a deformation of at least a part of the electronic device 101 being detected. However, this should not be considered as limiting.

FIG. 16B illustrates an operation of the electronic device (for example, the processor 120) restoring the at least bent part of the electronic device by performing the task related to the timer function in the state in which the at least a part of the electronic device 101 is deformed, for example, is bent. FIG. 16B illustrates an example in which the electronic device 101 is bent such that its center faces downwards with reference to both right and left edges of the electronic device 101. However, the deformation of the at least a part of the electronic device 101 is not limited to this. In an example embodiment, in a state in which at least a part of the electronic device 101 is bent to form a predetermined angle, the electronic device 101 may restore the at least bent part of the electronic device 101 at an equiangular velocity while performing the task related to the timer function. However, this should not be considered as limiting. In another example embodiment, in a state in which at least a part of the electronic device 101 is bent to form a predetermined angle, when an angle determined as a restoring angle per unit time is less than a specified angle, the electronic device (for example, the processor 120) may stop restoring until the restoring angle per unit time is equal to the specified angle and may restore by the specified angle per unit time from the time when the restoring angle per unit time is equal to the specified angle. In an example embodiment, when the electronic device (for example, the processor 120) may detect a deformation of at least a part of the electronic device 101 in the middle of performing the task related to the timer function, the electronic device (for example, the processor 120) may restore the at least deformed part of the electronic device 101 based on the remaining performance time of the task related to the timer function. In another example embodiment, when the electronic device (for example, the processor 120) starts performing the task related to the timer function in response to a deformation of at least a part of the electronic device 101, the electronic device (for example, the processor 120) may restore the at least deformed part of the electronic device 101 at the same of performing the task. However, this should not be considered as limiting.

In an example embodiment, when a specified time passes in the state of the electronic device 101 illustrated in FIG. 16B, the display 160 of the electronic device 101 may be turned off as illustrated in FIG. 16C. However, the operation of the display 160 of the electronic device 101 being turned off after the specified time passes may be omitted according to an example embodiment.

In an example embodiment, when the time set by the timer function passes, the electronic device (for example, the processor 120) may complete the restoring of the at least deformed part of the electronic device 101. In an example embodiment, when the elapsed time is 19 seconds longer than the time set by the timer function as illustrated in FIG. 16D, the electronic device (for example, the processor 120) may display the elapsed time through a pop-up window 1603.

In an example embodiment, the electronic device (for example, the processor 120) may provide the result of performing the designated task or a notification on the completion of the task periodically in various ways. For example, while the task related to the timer function is being performed or when the task is completed, the electronic device 101 may provide a notification on the elapsed time at a specified timer interval (for example, every 1 minute). The electronic device (for example, the processor 120) may output at least one of a notification window display, a sound, haptic feedback, and light to provide the notification. However, this should not be considered as limiting.

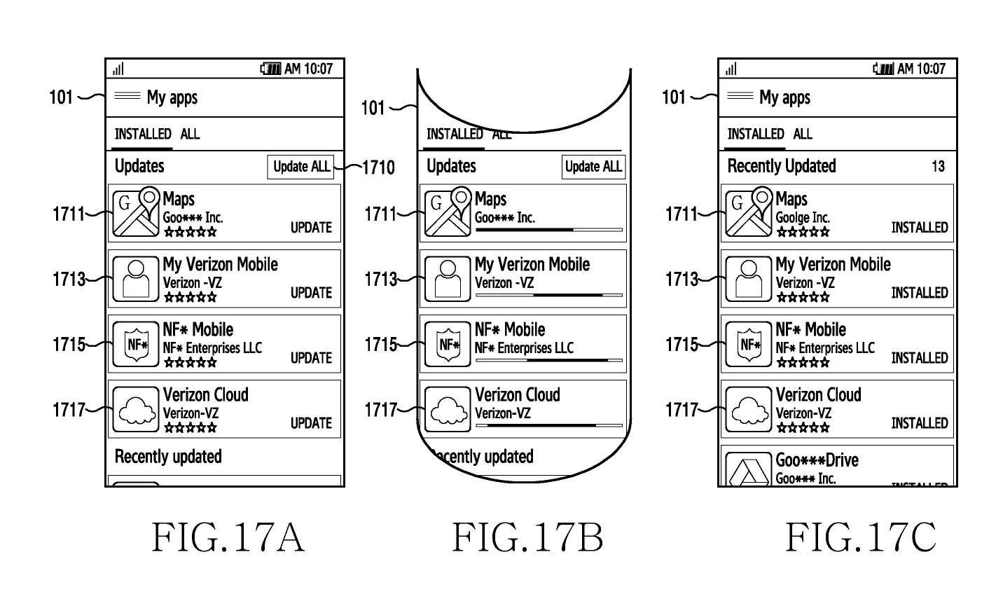

FIGS. 17A, 17B and 17C are diagrams illustrating an example method for performing a task related to an application update function according to an example embodiment of the present disclosure.

FIG. 17A illustrates a screen for executing an application update function. For example, FIG. 17A illustrates a state in which at least one application 1711, 1713, 1715 and 1717 to be updated by a user input is selected. In an example embodiment, the electronic device (for example, the processor 120) may start performing the task related to the application update function based on various inputs. For example, the electronic device (for example, the processor 120) may start performing the task related to the application update function by receiving a touch input on a button 1710 for the user to start updating. In another example, the electronic device (for example, the processor 120) may start performing the task related to the application update function when detecting a deformation of at least a part of the electronic device 101. For example, as shown in FIG. 17A, the electronic device (for example, the processor 120) may determine that the task related to the application update function is a task designated for restoring, for example, a task which is scheduled to be completed at the same time when the task is performed (or the task is started). The electronic device (for example, the processor 120) may determine that the task related to the application update function is the task designated for restoring, and that the state in which at least one application 1711 to 1717 for updating is selected is a state in which the task can be performed. When it is determined that the task can be performed, the electronic device (for example, the processor 120) may start performing the task related to the application update function in response to a deformation of at least a part of the electronic device 101 being detected. However, this should not be considered as limiting.

FIG. 17B illustrates an operation of restoring the at least bent part of the electronic device 101 by performing the task related to the application update function in the state in which the at least a part of the electronic device is deformed, for example, is bent. FIG. 17B illustrates an example in which the electronic device 101 is bent such that its center faces downwards with reference to both right and left edges. However, the deformation of the at least a part of the electronic device 101 is not limited to this. In an example embodiment, when at least a part of the electronic device 101 is bent to form a predetermined angle, the electronic device (for example, the processor 120) may restore the at least bent part of the electronic device 101 at a variable angular velocity while performing the task related to the application update function. However, this should not be considered as limiting. In an example embodiment, when the electronic device (for example, the processor 120) detects a deformation of at least a part of the electronic device 101 while performing the task related to the application update function, the electronic device (for example, the processor 120) may restore the at least deformed part of the electronic device 101 in consideration of a remaining performance time of the task related to the application update function. In another example embodiment, when the electronic device (for example, the processor 120) starts performing the task related to the application update function in response to a deformation of at least a part of the electronic device 101, the electronic device (for example, the processor 120) may restore the at least deformed part of the electronic device 101 at the same time of performing the task. However, this should not be considered as limiting.

In an example embodiment, when the electronic device (for example, the processor 120) completes the updating of the application through the application update function as illustrated in FIG. 17C, the electronic device (for example, the processor 120) may complete the restoring of the at least deformed part of the electronic device 101. For example, FIG. 17C illustrates a screen indicating the completion of the updating, and illustrates the state in which the restoring of the at least deformed part of the electronic device 101 is completed.

In an example embodiment, the electronic device (for example, the processor 120) may periodically provide the result of the performing the designated task or a notification on the completion of the task in various ways. For example, the electronic device (for example, the processor 120) may provide the notification at a specified interval (for example, every 1 minute) or based on the degree of task performance (for example, a ratio of capacity of updated files to the capacity of all update files) while performing the task related to the application update function or when completing the task. The electronic device (for example, the processor 120) may output at least one of a notification window display, a sound, haptic feedback, and light to provide the notification. However, this should not be considered as limiting.

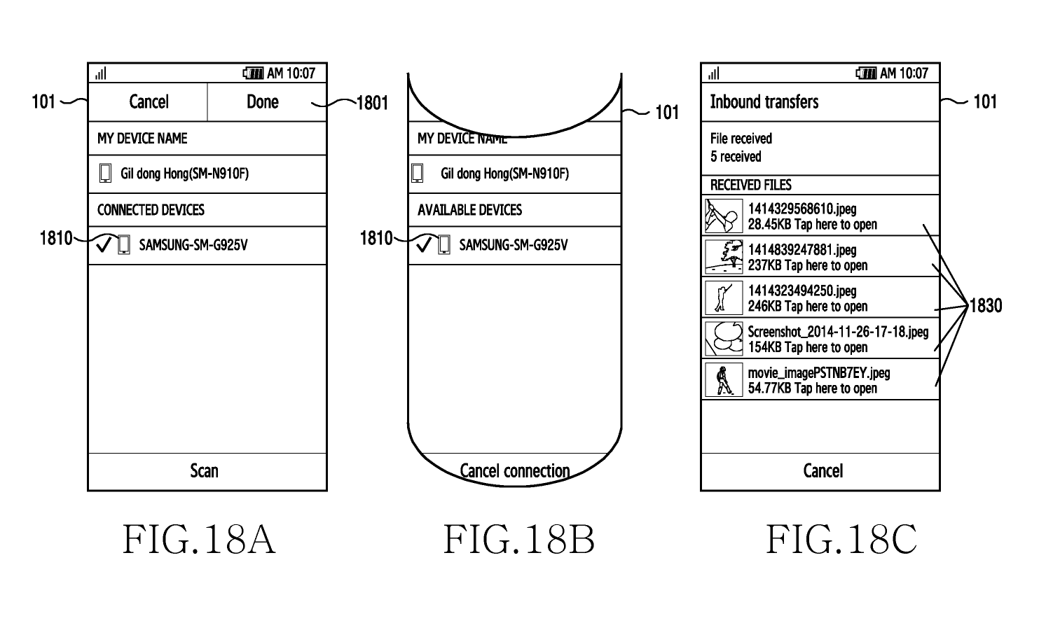

FIGS. 18A to 18C are diagrams illustrating an example method for performing a task related to file transmission according to an example embodiment of the present disclosure.

FIG. 18A illustrates a screen for executing a file transmission function. For example, FIG. 18A illustrates a state in which a file to be transmitted and another electronic device 1810 that the electronic device 101 intends to connect using, for example, Bluetooth communication are selected by a user input. In an example embodiment, the electronic device (for example, the processor 120) may start performing a task related to the file transmission function based on various inputs. For example, the electronic device (for example, the processor 120) may start performing the task related to the file transmission function by receiving a touch input on a button 1801 for the user to start transmitting a file. In another example, the electronic device (for example, the processor 120) may start performing the task related to the file transmission function when detecting a deformation of at least a part of the electronic device 101. For example, as illustrated in FIG. 18A, the electronic device (for example, the processor 120) may determine that the task related to the file transmission function is a task designated for restoring, for example, a task which is scheduled to be completed at the same time when the task is performed (or the task is started). In one embodiment, the electronic device (for example, the processor 120) may determine that the task related to the file transmission function is the task designated for restoring and that the state in which the file to be transmitted and another electronic device to be connected for communication are selected is a state in which the task can be performed. When it is determined that the task can be performed, the electronic device (for example, the processor 120) may start performing the task related to the file transmission function in response to a deformation of at least a part of the electronic device 101 being detected. However, this should not be considered as limiting.

FIG. 18B illustrates an operation of restoring the at least bent part of the electronic device 101 by performing the task related to the file transmission function in the state in which the at least a part of the electronic device is deformed, for example, is bent. FIG. 18B illustrates an example in which the electronic device 101 is bent such that its center faces downwards with reference to both right and left edges. However, the deformation of the at least a part of the electronic device 101 is not limited to this. In an example embodiment, when at least a part of the electronic device 101 is bent to form a predetermined angle, the electronic device (for example, the processor 120) may restore the at least bent part of the electronic device 101 at a variable angular velocity while performing the task related to the file transmission function. However, this should not be considered as limiting. In an example embodiment, when the electronic device (for example, the processor 120) detects a deformation of at least a part of the electronic device 101 while performing the task related to the file transmission function, the electronic device (for example, the processor 120) may restore the at least deformed part of the electronic device 101 in consideration of a remaining performance time of the task related to the file transmission function. In another example embodiment, when the electronic device (for example, the processor 120) starts performing the task related to the file transmission function in response to a deformation of at least a part of the electronic device 101, the electronic device (for example, the processor 120) may restore the at least deformed part of the electronic device 101 at the same time of performing the task. However, this should not be considered as limiting.

In an example embodiment, when the electronic device (for example, the processor 120) completes the file transmission through the file transmission function as illustrated in FIG. 18C, the electronic device (for example, the processor 120) may complete the restoring of the at least deformed part of the electronic device 101. For example, FIG. 18C illustrates a screen displaying a list of files 1830 which have been transmitted, and illustrates the state in which the restoring of the at least deformed part of the electronic device 101 is completed.

In an example embodiment, the electronic device (for example, the processor 120) may periodically provide the result of the performing the designated task or a notification on the completion of the task in various ways. For example, the electronic device (for example, the processor 120) may provide the notification at a specified interval (for example, every 1 minute) or based on the degree of task performance (for example, a ratio of capacity of transmitted files to the capacity of all transmission files) while performing the task related to the file transmission function or when completing the task. The electronic device 101 may output at least one of a notification window display, a sound, haptic feedback, and light to provide the notification. However, this should not be considered as limiting.

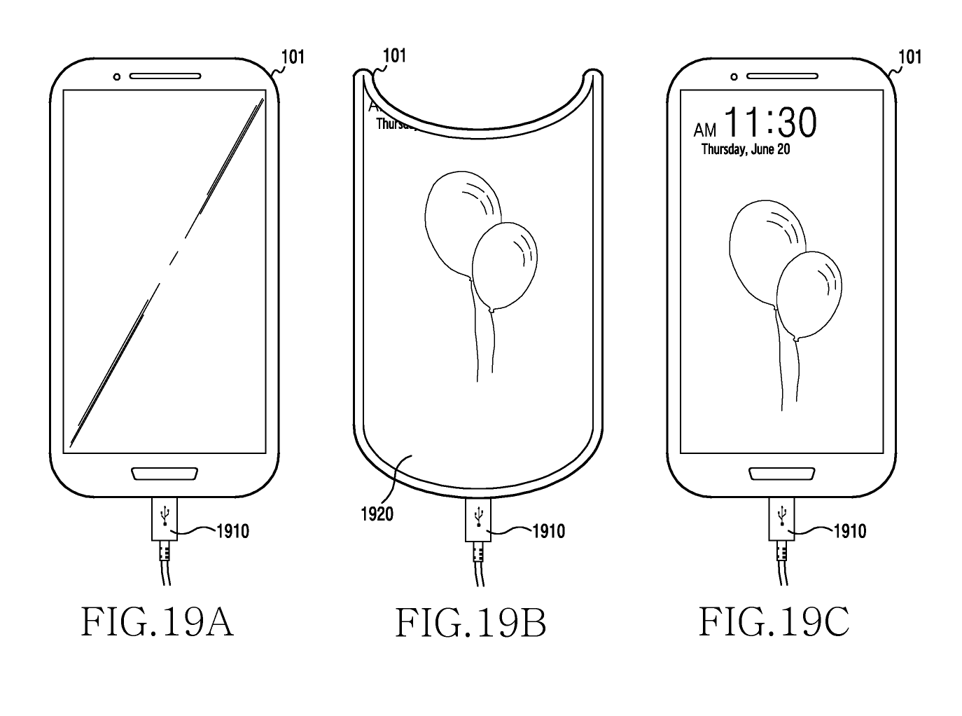

FIGS. 19A, 19B and 19C are diagrams illustrating an example method for performing a task related to a charging function according to an example embodiment of the present disclosure.

FIG. 19A illustrates a state in which a charging function is to be executed. For example, FIG. 19A illustrates a state in which a charging cable 1910 is connected to the electronic device 101. In an example embodiment, the electronic device (for example, the processor 120) may start performing a task related to the charging function based on various inputs. For example, when the charging cable 1910 is inserted into the electronic device 101, the electronic device (for example, the processor 120) may start performing the task related to the charging function. In another example, the electronic device (for example, the processor 120) may start performing the task related to the charging function when detecting a deformation of at least a part of the electronic device 101. For example, the electronic device (for example, the processor 120) may determine that the task related to the charging function is a task designated for restoring, for example, a task which is scheduled to be completed at the same time when the task is performed (or the task is started). The electronic device (for example, the processor 120) may determine that the task related to the charging function is the task designated for restoring, and that the state in which the charging cable 1910 is connected to the electronic device 101 is a state in which the task can be performed. When it is determined that the task can be performed, the electronic device (for example, the processor 120) may start performing the task related to the charging function in response to a deformation of at least a part of the electronic device 101 being detected. However, this should not be considered as limiting.

FIG. 19B illustrates an operation of restoring the at least bent part of the electronic device 101 by performing the task related to the charging function in the state in which the at least a part of the electronic device is deformed, for example, is bent. In one embodiment, as shown in FIG. 19B, the electronic device (for example, the processor 120) may display a lock screen 1920 while performing the task related to the charging function. However, this should not be considered as limiting. In an example embodiment, FIG. 19B illustrates a case in which the electronic device 101 is bent such that its center faces downwards with reference to both right and left edges. However, the deformation of the at least a part of the electronic device 101 is not limited to this. In an example embodiment, when at least a part of the electronic device 101 is bent to form a predetermined angle, the electronic device (for example, the processor 120) may restore the at least bent part of the electronic device 101 at a uniform velocity or at a variable angular velocity while performing the task related to the charging function. However, this should not be considered as limiting. In an example embodiment, when the electronic device (for example, the processor 120) detects a deformation of at least a part of the electronic device 101 while performing the task related to the charging function, the electronic device (for example, the processor 120) may restore the at least deformed part of the electronic device 101 10 based on a remaining performance time of the task related to the charging function. In another example embodiment, when the electronic device (for example, the processor 120) starts performing the task related to the charging function in response to a deformation of at least a part of the electronic device 101, the electronic device (for example, the processor 120) may restore the at least deformed part of the electronic device 101 at the same time of performing the task. However, this should not be considered as limiting.

In an example embodiment, when the electronic device (for example, the processor 120) completes the charging through the charging function as illustrated in FIG. 19C, the electronic device (for example, the processor 120) may complete the restoring of the at least deformed part of the electronic device 101. For example, FIG. 19C illustrates a screen indicating the completion of the charging, and illustrates the state in which the restoring of the at least deformed part of the electronic device 101 is completed.

In an example embodiment, the electronic device (for example, the processor 120) may periodically provide the result of the performing the designated task or a notification on the completion of the task in various ways. For example, the electronic device (for example, the processor 120) may provide the notification at a specified interval (for example, every 1 minute) or based on the degree of task performance (for example, a degree of charging (or a charging level)) while performing the task related to the charging function or when completing the task. The electronic device (for example, the processor 120) may output at least one of a notification window display, a sound, haptic feedback, and light to provide the notification. However, this should not be considered as limiting.

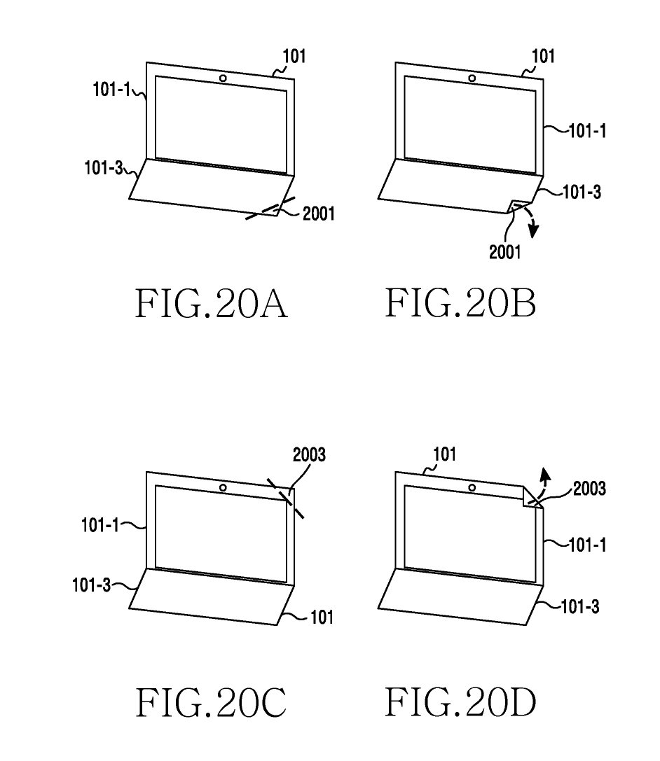

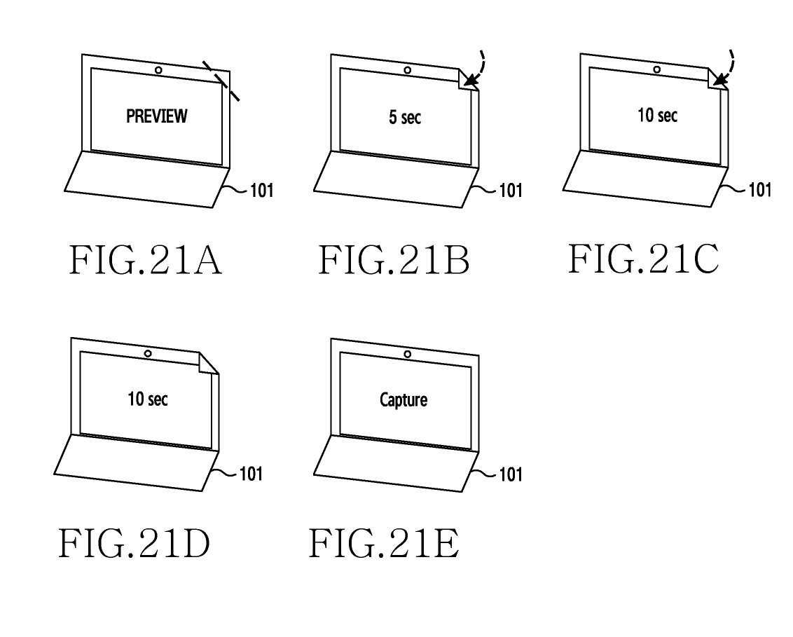

FIGS. 20A, 20B, 20C and 20D and FIGS. 21A, 21B, 21C, 21D and 21E are diagrams illustrating an example method for performing a task related to an automatic photographing function of a camera according to an example embodiment of the present disclosure.

Referring to FIGS. 20A to 20D and FIGS. 21A to 21E, to execute the automatic photographing function of the camera, the user may bend, fold, or roll at least a part of the electronic device 101. In an example embodiment, FIGS. 20A to 20D and FIGS. 21A to 21E illustrate a case in which at least a part of the electronic device 101 is folded, but this should not be considered as limiting.

In an example embodiment, at least a part of the electronic device 101 may be folded in order for the electronic device 101 to be held or mounted as illustrated in FIGS. 20A to 20D. For example, the electronic device 101 may be folded to have a part 101-3 of the electronic device 101 laid on the ground and to have the other part 101-1 of the electronic device 101 stand.

In an example embodiment, various parts of the electronic device 101 may be deformed, for example, be folded. For example, as illustrated in FIGS. 20A and 20B, a corner 2001 of the part 101-3 of the electronic device 101 may be folded. In another example, as illustrated in FIGS. 20C and 20D, a corner 2003 of the other part 101-1 of the electronic device 101 may be folded. However, the deformed parts of the electronic device 101 are not limited to these.

In an example embodiment, FIG. 21A illustrates a screen for executing the automatic photographing function of the camera. For example, in FIG. 21A, the electronic device (for example, the processor 120) may display a preview on a subject.

In an example embodiment, the electronic device (for example, the processor 120) may set a task performance time for the automatic photographing function of the camera based on at least a user's touch input. In another embodiment, the electronic device (for example, the processor 120) may detect a deformation of at least a part of the electronic device 101, and set the task performance time for the automatic photographing function of the camera based on the deformation of the at least a part of the electronic device 201. For example, the electronic device (for example, the processor 120) may set the task performance time for the automatic photographing function of the camera to be a fixed time according to the deformation of the at least a part of the electronic device, or may set the task performance time for the automatic photographing function of the camera based on at least a degree of deformation of a at least a part of the electronic device 101, the number of times at least a part of the electronic device 101 is deformed, or a time during which the user contacts the electronic device 101. For example, when at least a part of the electronic device 101 is deformed one time in FIG. 21B, the electronic device (for example, the processor 120) may set the task performance time to 5 seconds, and, when at least a part of the electronic device 101 is deformed two times in FIG. 21C, the electronic device (for example, the processor 120) may set the task performance time to 10 seconds. However, this should not be considered as limiting.

In an example embodiment, the electronic device (for example, the processor 120) may start performing the task related to the automatic photographing function of the camera based on various inputs. For example, the electronic device (for example, the processor 120) may start performing the task related to the automatic photographing function of the camera by receiving a user's input. In another example, the electronic device (for example, the processor 120) may start performing the task related to the automatic photographing function of the camera when detecting a deformation of at least a part of the electronic device 101. For example, as illustrated in FIG. 20C, the electronic device (for example, the processor 120) may determine that the task related to the automatic photographing function of the camera is a task designated for restoring, for example, a task for which a task performance time is specified at the same time when the task is performed (or the task is started). The electronic device (for example, the processor 120) may determine that the task related to the automatic photographing function of the camera is the task designated for restoring, and that the state in which the task performance time for the automatic photographing function of the camera is set as illustrated in FIG. 21C is a state in which the task can be performed. When it is determined that the task can be performed, the electronic device (for example, the processor 120) may start performing the task related to the automatic photographing function of the camera in response to a deformation of at least a part of the electronic device 101 being detected. However, this should not be considered as limiting.

FIGS. 21D and 21E illustrate an operation of restoring the at least folded part of the electronic device 101 by performing the task related to the automatic photographing function of the camera in the state in which the at least a part of the electronic device is deformed, for example, is folded

In an example embodiment, when at least a part of the electronic device 101 is folded to form a predetermined angle, the electronic device (for example, the processor 120) may restore the at least folded part of the electronic device 101 at an equiangular velocity while performing the task related to the automatic photographing function of the camera. However, this should not be considered as limiting. In another example embodiment, the electronic device (for example, the processor 120) may determine a restoring angle in the state in which the at least a part of the electronic device is folded to form the predetermined angle. In an example embodiment, when a determined restoring angle per unit time is less than a specified angle, the electronic device (for example, the processor 120) may stop restoring until the angle restored per unit time is equal to the specified angle, and may restore by the specified angle per unit time from the time when the angle restored per unit time is equal to the specified angle. In an example embodiment, when the electronic device (for example, the processor 120) detects a deformation of at least a part of the electronic device 101 while performing the task related to the automatic photographing function of the camera, the electronic device (for example, the processor 120) may restore the at least deformed part of the electronic device 101 based on a remaining performance time of the task related to the automatic photographing function of the camera. In another example embodiment, when the electronic device (for example, the processor 120) starts performing the task related to the automatic photographing function of the camera in response to a deformation of at least a part of the electronic device 101, the electronic device (for example, the processor 120) may restore the at least deformed part of the electronic device 101 at the same time of performing the task. However, this should not be considered as limiting.

In an example embodiment, when the time set in the automatic photographing function of the camera passes, the electronic device (for example, the processor 120) may complete the restoring of the at least deformed part of the electronic device 101, as illustrated in FIG. 21E.

In an example embodiment, the electronic device (for example, the processor 120) may periodically provide the result of the performing the designated task or a notification on the completion of the task in various ways. For example, the electronic device (for example, the processor 120) may provide a notification on the elapsed time at a specified interval (for example, every 1 minute) while performing the task related to the automatic photographing function of the camera or when completing the task. The electronic device (for example, the processor 120) may output at least one of a notification window display, a sound, haptic feedback, and light to provide the notification. However, this should not be considered as limiting.

According to various example embodiments of the present disclosure, a method for performing a task in an electronic device may include: detecting a deformation of at least a part of the electronic device; identifying information on a task which is performed in the electronic device; and restoring the at least a part of the electronic device from which the deformation is detected based on at least the identified information on the task.

In an example embodiment, the detecting the deformation of the at least a part of the electronic device may include detecting at least one of bending, folding, and rolling of the at least a part of the electronic device.

In an example embodiment, the identifying the information on the task which is performed in the electronic device may include determining whether the task is a task which is designated for restoring the at least a part of the electronic device or not, and the task designated for restoring the at least a part of the electronic device may include a task for which a task performance time is determined when the task is started.

In an example embodiment, the task designated for restoring the at least a part of the electronic device may include a task related to a timer function, a task related to an application update, a task related to file transmission, a task related to file download, a task related to an automatic photographing function of a camera, and a task related to a charging function.

In an example embodiment, the identifying the information on the task which is performed in the electronic device may include: determining whether it is possible to perform the task designated for restoring the at least a part of the electronic device; and, when it is determined that it is possible to perform the task designated for restoring the at least a part of the electronic device, starting performing the task designated for restoring the at least a part of the electronic device.

In an example embodiment, the restoring the at least a part of the electronic device from which the deformation is detected based on at least the identified information on the task may include: determining whether to restore the at least a part of the electronic device from which the deformation is detected based on at least the identified information of the task; when it is determined that the at least a part of the electronic device from which the deformation is detected is restored, restoring the at least a part of the electronic device from which the deformation is detected by performing the task; and when it is determined that the at least a part of the electronic device from which the deformation is detected is not restored, performing the task while maintaining the deformation of the at least a part of the electronic device.

In an example embodiment, the detecting the deformation of the at least a part of the electronic device may include detecting that the at least a part of the electronic device is deformed to form a predetermined angle, and the restoring the at least a part of the electronic device from which the deformation is detected based on at least the identified information on the task may include: identifying a task performance time which remains until the identified task is completed at a specified timer interval; determining whether a change rate of the task performance time remaining until the identified task is completed is constant or not; calculating an angle per unit time for restoring the at least a part of the electronic device from which the deformation is detected; when the change rate of the task performance time remaining until the identified task is completed is constant, restoring the at least a part of the electronic device from which the deformation is detected from the predetermined angle at an equiangular velocity; and when the change rate of the task performance time remaining until the identified task is completed is variable, restoring the at least a part of the electronic device from which the deformation is detected from the predetermined angle at a variable angular velocity.

In an example embodiment, the restoring the at least a part of the electronic device from which the deformation is detected based on at least the identified information on the task may include: determining whether the determined angle per unit time is greater than or equal to a specified angle; when the determined angle per unit time is greater than or equal to the specified angle, restoring the at least a part of the electronic device by the determined angle per unit time; and, when the determined angle per unit time is less than the specified angle, stopping restoring the at least a part of the electronic device until the determined angle per unit time is equal to the specified angle, and restoring the at least a part of the electronic device from a time when the determined angle per unit time is equal to the specified angle.

In an example embodiment, the restoring the at least a part of the electronic device from which the deformation is detected based on at least the identified information on the task may further include, after detecting the deformation of the at least a part of the electronic device, determining whether to restore the at least a part of the electronic device based on whether there is a user input or a movement of the electronic device.

In an example embodiment, the method may further include setting a performance time of the task as a fixed time based on at least the deformation of the at least a part of the electronic device, or setting the performance time of the task based on at least one of a degree of deformation of the at least a part of the electronic device, a number of times the at least a part of the electronic device is deformed, and a time during which a user contacts the at least a part of the electronic device.

The method for performing the task and the electronic device supporting the same according to various example embodiments of the present disclosure can provide the results of performing tasks of various functions of the electronic device using the operations of deforming the electronic device and returning the deformed electronic device to its original state.

In addition, the structure of data used in the above-described embodiments of the present disclosure may be recorded on a computer-readable recording medium through various means. The computer-readable recording medium may include storage media such as a magnetic storage medium (for example, a Read Only Memory (ROM), a floppy disk, a hard disk, or the like), and an optical reading medium (for example, a compact disk(CD)-ROM, a Digital Versatile Disk (DVD), or the like).

In an example embodiment, the storage medium stores instructions, and the instruction may be set for at least one processor to perform at least one operation when the instructions are executed by the at least one processor, and the at least one operation includes: in an electronic device including a memory and a processor, detecting a deformation of at least a part of the electronic device; identifying information on a task which is performed in the electronic device; and restoring the at least a part of the electronic device from which the deformation is detected based on at least the identified information on the task. The storage medium may include a computer readable storage device having a program recorded thereon, for executing the at least one operation.

Although the disclosure herein has been described with reference to various examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while example processes are illustrated in a specific order in the appended drawings, such processes are not limited to any particular order unless such order is expressly set forth herein; rather, processes may be performed in a different order or concurrently and steps may be added or omitted.

What is claimed is:

1. A method for performing a task in an electronic device, the method comprising:
detecting a deformation of at least a part of the electronic device;
identifying information on a task which is performed in the electronic device; and
restoring the deformation of at least a part of the electronic device from which the deformation is detected based on at least the identified information on the task.

2. The method of claim 1, wherein the detecting the deformation of the at least a part of the electronic device comprises detecting at least one of:
bending, folding, and rolling of the at least a part of the electronic device.

3. The method of claim 1, wherein the identifying the information on the task which is performed in the electronic device comprises: determining whether the task is a task designated for restoring the at least a part of the electronic device, and
wherein the task designated for restoring the at least a part of the electronic device comprises: a task for which a task performance time is determined when the task is started.

4. The method of claim 3, wherein the task designated for restoring the at least a part of the electronic device comprises one or more of: a task related to a timer function, a task related to an application update, a task related to file transmission, a task related to file download, a task related to an automatic photographing function of a camera, and a task related to a charging function.

5. The method of claim 1, wherein the identifying the information on the task which is performed in the electronic device comprises:
determining whether it is possible to perform the task designated for restoring the at least a part of the electronic device; and
when it is determined that it is possible to perform the task designated for restoring the at least a part of the electronic device, starting performing the task designated for restoring the at least a part of the electronic device.

6. The method of claim 1, wherein the restoring the at least a part of the electronic device from which the deformation is detected based on at least the identified information on the task comprises:
determining whether to restore the at least a part of the electronic device from which the deformation is detected based on at least the identified information of the task;
when it is determined that the at least a part of the electronic device from which the deformation is detected is to be restored, restoring the at least a part of the electronic device from which the deformation is detected by performing the task; and
when it is determined that the at least a part of the electronic device from which the deformation is detected is not restored, performing the task while maintaining the deformation of the at least a part of the electronic device.

7. The method of claim 1, wherein the detecting the deformation of the at least a part of the electronic device comprises: detecting that the at least a part of the electronic device is deformed to form a predetermined angle, and
wherein the restoring the at least a part of the electronic device from which the deformation is detected based on at least the identified information on the task comprises:
identifying a task performance time remaining until the identified task is completed at a specified timer interval;
determining whether a change rate of the task performance time remaining until the identified task is completed is constant;
determining an angle per unit time for restoring the at least a part of the electronic device from which the deformation is detected;
when the change rate of the task performance time remaining until the identified task is completed is constant, restoring the at least a part of the electronic device from which the deformation is detected from the predetermined angle at an equiangular velocity; and
when the change rate of the task performance time remaining until the identified task is completed is not constant, restoring the at least a part of the electronic device from which the deformation is detected from the predetermined angle at a variable angular velocity.

8. The method of claim 7, wherein the restoring the at least a part of the electronic device from which the deformation is detected based on at least the identified information on the task comprises:
determining whether the determined angle per unit time is greater than or equal to a specified angle;
when the determined angle per unit time is greater than or equal to the specified angle, restoring the at least a part of the electronic device by the determined angle per unit time; and
when the determined angle per unit time is less than the specified angle, stopping restoring the at least a part of the electronic device until the determined angle per unit time is equal to the specified angle, and restoring the at least a part of the electronic device from a time when the determined angle per unit time is equal to the specified angle.

9. The method of claim 1, wherein the restoring the at least a part of the electronic device from which the deformation is detected based on at least the identified information on the task further comprises, after detecting the deformation of the at least a part of the electronic device, determining whether to restore the at least a part of the electronic device based on whether there is a received input or a movement of the electronic device.

10. The method of claim 1, further comprising setting a performance time of the task as a fixed time based on at least one of: at least the deformation of the at least a part of the electronic device, setting the performance time of the task based on at least one of a degree of deformation of the at least a part of the electronic device, a number of times the at least a part of the electronic device is deformed, and a time during which a user contacts the at least a part of the electronic device.

11. An electronic device comprising:
at least one sensor configured to detect a deformation of at least a part of the electronic device;
a driver unit comprising driving circuitry configured to restore the at least deformed part of the electronic device; and
at least one processor electrically connected with the at least one sensor and the driver unit,
wherein the processor is configured to control the driver unit to detect a deformation of at least a part of the electronic device using the at least one sensor, to identify information on a task which is performed in the electronic device, and to restore the at least deformed part of the electronic device from which the deformation is detected based on at least the identified information on the task.

12. The electronic device of claim 11, wherein the processor is configured to detect at least one of: bending, folding, and rolling of the at least a part of the electronic device using the at least one sensor.

13. The electronic device of claim 11, wherein the processor is configured to determine whether the task is a task designated for restoring the at least a part of the electronic device, and
wherein the task designated for restoring the at least a part of the electronic device comprises: a task for which a task performance time is determined when the task is started.

14. The electronic device of claim 13, wherein the task designated for restoring the at least a part of the electronic device comprises one or more of:
a task related to a timer function, a task related to an application update, a task related to file transmission, a task related to file download, a task related to an automatic photographing function of a camera, and a task related to a charging function.

15. The electronic device of claim 11, wherein the processor is configured to determine whether it is possible to perform the task designated for restoring the at least a part of the electronic device, and, when it is determined that it is possible to perform the task designated for restoring the at least a part of the electronic device, to start performing the task designated for restoring the at least a part of the electronic device.

16. The electronic device of claim 11, wherein the processor is configured to: determine whether to restore the at least a part of the electronic device from which the deformation is detected based on at least the identified information of the task; when it is determined that the at least a part of the electronic device from which the deformation is detected is to be restored, restore the at least a part of the electronic device from which the deformation is detected by performing the task; and when it is determined that the at least a part of the electronic device from which the deformation is detected is not to be restored, perform the task while maintaining the deformation of the at least a part of the electronic device.

17. The electronic device of claim 11, wherein the processor is configured to detect that the at least a part of the electronic device is deformed to form a predetermined angle using the at least one sensor, and is configured to identify a task performance time which remains until the identified task is completed at a specified timer interval; to determine whether a change rate of the task performance time remaining until the identified task is completed is constant; to determine an angle per unit time for restoring the at least a part of the electronic device from which the deformation is detected; when the change rate of the task performance time remaining until the identified task is completed is constant, to restore the at least a part of the electronic device from which the deformation is detected from the predetermined angle at an equiangular velocity; and, when the change rate of the task performance time remaining until the identified task is completed is not constant, to restore the at least a part of the electronic device from which the deformation is detected from the predetermined angle at a variable angular velocity.

18. The electronic device of claim 17, wherein the processor is configured to: determine whether the determined angle per unit time is greater than or equal to a specified angle; when the determined angle per unit time is greater than or equal to the specified angle, restore the at least a part of the electronic device by the determined angle per unit time; and, when the determined angle per unit time is less than the specified angle, stop restoring the at least a part of the electronic device until the determined angle per unit time is equal to the specified angle, and restore the at least a part of the electronic device from a time when the determined angle per unit time is equal to the specified angle.

19. The electronic device of claim 11, wherein the processor is configured to, after detecting the deformation of the at least a part of the electronic device, determine whether to restore the at least a part of the electronic device based on whether there is a received input or a movement of the electronic device.

20. The electronic device of claim 11, wherein the processor is configured to set a performance time of the task as a fixed time based on at least the deformation of the at least a part of the electronic device, or to set the performance time of the task based on at least one of: a degree of deformation of the at least a part of the electronic device, a number of times the at least a part of the electronic device is deformed, and a time during which a user contacts the at least a part of the electronic device.
